(19) United States
(12) Patent Application Publication
(10) Pub. No.: US 2026/0253616 A1
(43) Pub. Date: Aug. 27, 2026

(54) SYSTEM

(71) Applicant: SoftBank Group Corp., Tokyo (JP)

(72) Inventor: Atsushi NANSEN, Tokyo (JP)

(73) Assignee: SoftBank Group Corp., Tokyo (JP)

(21) Appl. No.: 19/534,997

(22) Filed: Feb. 10, 2026

(30) Foreign Application Priority Data
Feb. 21, 2025 (JP) 2025-027016

(51) Int. Cl. G11B 27/28; G11B 27/031; G11B 27/034

(52) U.S. Cl. CPC G11B 27/28; G11B 27/031; G11B 27/034

(57) ABSTRACT

The system according to the embodiment comprises a receiving unit, an analysis unit, a generation unit, a playback unit, and a formatting unit. The receiving unit loads a video. The analysis unit analyzes the video loaded by the receiving unit. The generation unit generates minutes based on the video analyzed by the analysis unit. The playback unit plays back the video based on a search word. The formatting unit generates minutes in a specified format.

### CROSS-REFERENCE TO RELATED APPLICATION

The present application claims priority to and incorporates by reference the entire contents of Japanese Patent Application No. 2025-027016 filed in Japan on Feb. 21, 2025.

### BACKGROUND OF THE INVENTION

### 1. Field of the Invention

The technology of this disclosure relates to a system.

### 2. Description of the Related Art

Japanese Patent Application Laid-open No. 2022-180282 discloses a persona chatbot control method executed by at least one processor, comprising: receiving a user utterance, adding the user utterance to a prompt containing instructions related to the character of the chatbot, encoding the prompt, inputting the encoded prompt into a language model, and generating a chatbot utterance in response to the user utterance.

In conventional technology, there has been a problem that the task of creating minutes from videos requires significant effort and time, making it difficult to perform efficiently.

### SUMMARY OF THE INVENTION

The system according to the embodiment comprises a receiving unit, an analysis unit, a generation unit, a playback unit, and a formatting unit. The receiving unit loads a video. The analysis unit analyzes the video loaded by the receiving unit. The generation unit generates minutes based on the video analyzed by the analysis unit. The playback unit plays back the video based on a search word. The formatting unit generates minutes in a specified format.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a conceptual diagram showing an example configuration of a data processing system according to the first embodiment;

FIG. 2 is a conceptual diagram showing an example of main functions of a data processing device and a smart device according to the first embodiment;

FIG. 3 is a conceptual diagram showing an example configuration of a data processing system according to the second embodiment;

FIG. 4 is a conceptual diagram showing an example of main functions of a data processing device and smart glasses according to the second embodiment;

FIG. 5 is a conceptual diagram showing an example configuration of a data processing system according to the third embodiment;

FIG. 6 is a conceptual diagram showing an example of main functions of a data processing device and a headset-type terminal according to the third embodiment;

FIG. 7 is a conceptual diagram showing an example configuration of a data processing system according to the fourth embodiment;

FIG. 8 is a conceptual diagram showing an example of main functions of a data processing device and a robot according to the fourth embodiment;

FIG. 9 shows an emotion map where multiple emotions are mapped; and

FIG. 10 shows an emotion map where multiple emotions are mapped.

### DETAILED DESCRIPTION OF THE PREFERRED EMBODIMENTS

Hereinafter, an example of an embodiment of the system related to the technology disclosed herein will be described with reference to the attached drawings.

First, the terminology used in the following description will be explained.

In the following embodiments, a processor denoted by a reference numeral (hereinafter simply referred to as “processor”) may be a single computing device or a combination of multiple computing devices. The processor may be a single type of computing device or a combination of multiple types of computing devices. Examples of computing devices include a CPU (Central Processing Unit), GPU (Graphics Processing Unit), GPGPU (General-Purpose computing on Graphics Processing Units), APU (Accelerated Processing Unit), or TPU (Tensor Processing Unit), among others.

In the following embodiments, a RAM (Random Access Memory) denoted by a reference numeral is a memory where information is temporarily stored and used as a work memory by the processor.

In the following embodiments, a storage denoted by a reference numeral is one or more non-volatile storage devices for storing various programs and parameters. Examples of non-volatile storage devices include flash memory (SSD (Solid State Drive)), magnetic disks (e.g., hard disks), or magnetic tapes, among others.

In the following embodiments, a communication I/F (Interface) denoted by a reference numeral is an interface including a communication processor and an antenna, among others. The communication I/F manages communication between multiple computers. Examples of communication standards applicable to the communication I/F include wireless communication standards such as 5G (5th Generation Mobile Communication System), Wi-Fi (registered trademark), or Bluetooth (registered trademark), among others.

In the following embodiments, “A and/or B” means “at least one of A and B.” In other words, “A and/or B” means it may be only A, only B, or a combination of A and B. Moreover, when expressing three or more items connected by “and/or,” the same concept as “A and/or B” applies.

### First Embodiment

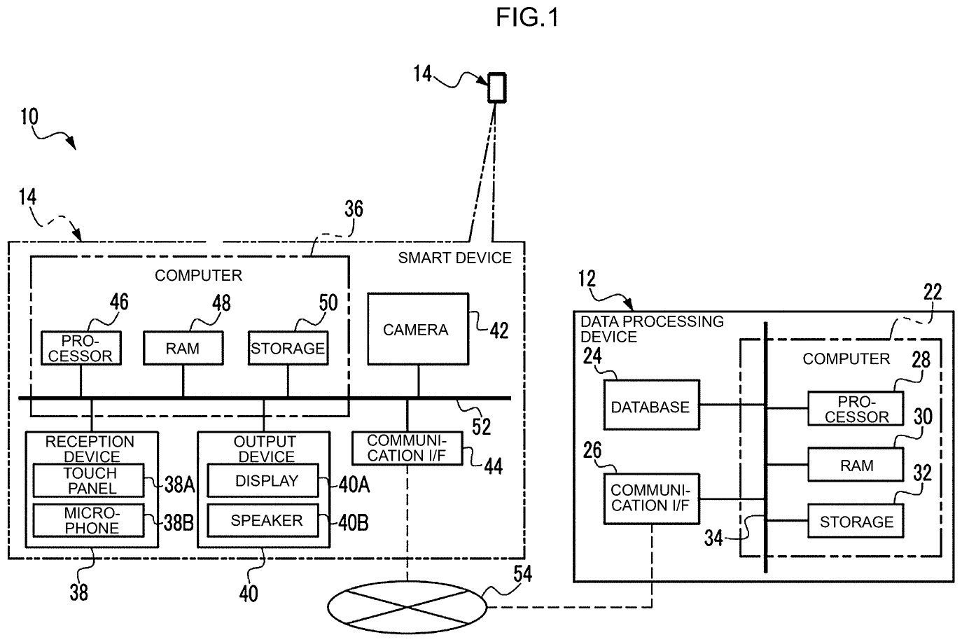

FIG. 1 shows an example configuration of a data processing system 10 according to the first embodiment.

As shown in FIG. 1, the data processing system 10 comprises a data processing device 12 and a smart device 14. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN (Wide Area Network) and/or a LAN (Local Area Network), among others.

The smart device 14 comprises a computer 36, a reception device 38, an output device 40, a camera 42, and a communication I/F 44. The computer 36 comprises a processor 46, RAM 48, and storage 50. The processor 46, RAM 48, and storage 50 are connected to a bus 52. The reception device 38, output device 40, and camera 42 are also connected to the bus 52.

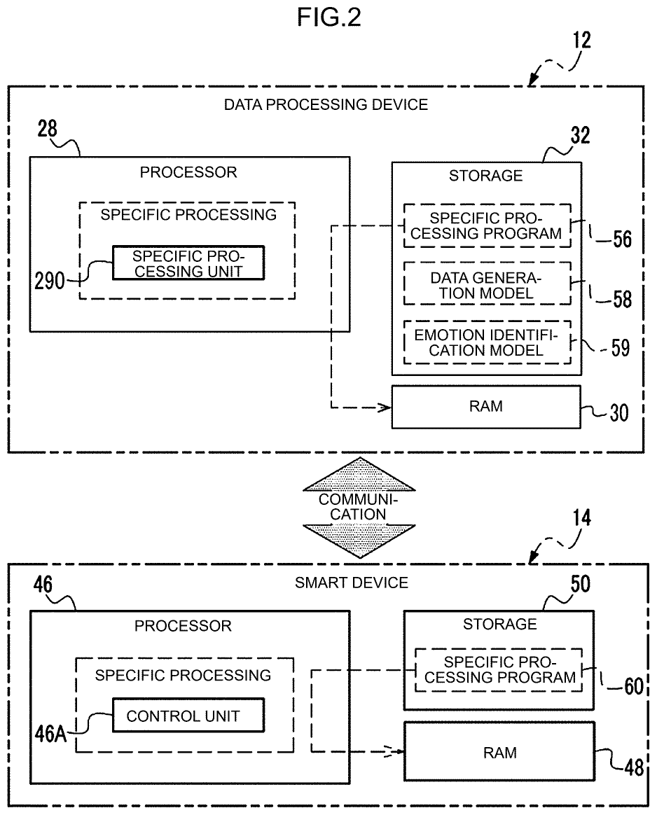

The reception device 38 comprises a touch panel 38A and a microphone 38B, among others, and accepts user input. The touch panel 38A accepts user input by detecting contact from an indicating object (e.g., a pen or finger). The microphone 38B accepts user input by detecting the user's voice. The control unit 46A sends data indicating user input accepted by the touch panel 38A and microphone 38B to the data processing device 12. The data processing device 12 has a specific processing unit 290 (see FIG. 2) that acquires data indicating user input.

The output device 40 comprises a display 40A and a speaker 40B, among others, and presents data to the user by outputting it in a perceptible form (e.g., audio and/or text). The display 40A displays visible information such as text and images according to instructions from the processor 46. The speaker 40B outputs audio according to instructions from the processor 46. The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors.

The communication I/F 44 is connected to the network 54. The communication I/F 44 and 26 manage the exchange of various information between the processor 46 and the processor 28 via the network 54.

FIG. 2 shows an example of the main functions of the data processing device 12 and the smart device 14.

As shown in FIG. 2, specific processing is performed in the data processing device 12 by the processor 28. The storage 32 stores a specific processing program 56. The specific processing program 56 is an example of a “program” related to the technology disclosed herein. The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart device 14, specific processing is performed by the processor 46. The storage 50 stores a specific processing program 60. The specific processing program 60 is used in conjunction with the specific processing program 56 by the data processing system 10. The processor 46 reads the specific processing program 60 from the storage 50 and executes it on the RAM 48. The specific processing is realized by the processor 46 operating as a control unit 46A according to the specific processing program 60 executed on the RAM 48. The smart device 14 may also have similar data generation models and emotion identification models as the data generation model 58 and emotion identification model 59, and perform the same processing as the specific processing unit 290 using these models.

Other devices besides the data processing device 12 may have the data generation model 58. For example, a server device (e.g., a generation server) may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.). Next, an example of processing by the data processing system 10 according to the first embodiment will be described.

### Example of the Embodiment

The system according to the embodiment of the present invention is a system for generating minutes simply by loading a video. When a user loads a video into the system, the system analyzes the video and generates minutes. There are two patterns of minutes generated: highlight video generation and text generation. In addition, the system is equipped with a function to play back the video from a few seconds before the appearance of an input search word, and a function to generate minutes in a specified format. For example, when a user loads a recording of a meeting, lecture, or class into the system, the video is input to the system. Next, the system analyzes the video, analyzes its content, and extracts important parts. For example, in the case of a meeting recording, the system extracts the content of each speaker's remarks and important parts of the discussion. In the case of a lecture or class recording, the system extracts the instructor's explanations and key points. The system generates minutes based on the extracted important parts. There are two patterns of minutes: highlight video generation and text generation. In highlight video generation, the extracted important parts are concatenated to generate a short highlight video. In text generation, the extracted important parts are summarized as text. Furthermore, the system is equipped with a function to play back the video from a few seconds before the appearance of an input search word. For example, if the user inputs the search word “key point,” the video can be played back from a few seconds before the word appears. This allows the user to quickly find important parts. The system also has a function to generate minutes in a specified format. For example, minutes can be generated in a specific format used for company meetings or in a format used for school classes. This enables users to easily create minutes tailored to their needs. This system can be utilized for creating minutes of meetings, lectures, and classes. For example, by loading a meeting recording into the system, important parts of the discussion can be extracted and highlight videos or text minutes can be generated. Similarly, by loading a lecture or class recording into the system, the instructor's explanations and key points can be extracted and highlight videos or text minutes can be generated. Furthermore, this system can also be used for summarizing TV programs and news. For example, by loading a recording of a TV program or news broadcast into the system, important parts can be extracted and highlight videos or text summaries can be generated. This allows users to grasp important information in a short time. Thus, minutes can be generated simply by loading a video. Specifically, the system comprises a receiving unit configured to accept video files (e.g., MP4, AVI, streaming formats, etc.) as input data; an analysis unit configured to perform multi-stage analysis of the video content; a generation unit configured to generate highlight videos and text minutes based on the results of important part extraction; a playback unit configured to control video playback according to user search words; and a formatting unit configured to specify the output format of the minutes, among other functional modules. The analysis unit receives video frame data (e.g., per-frame RGB image tensors, audio waveform data, text data extracted from audio, etc.) as input, and first uses convolutional neural networks (CNNs) for image recognition, recurrent neural networks (RNNs) for speech recognition, or Transformer-based multimodal models to perform face detection of speakers, extraction of speech segments, conversion of speech to text (automatic speech recognition), and extraction of important remarks using natural language processing. For example, input examples include “60-minute meeting video (1920×1080, 30 fps, stereo audio)” and “90-minute lecture video (1280×720, 24 fps, mono audio).” The analysis unit outputs, for these videos, speech segments for each speaker (e.g., with start and end timestamps), text conversion of speech content (e.g., “Today's agenda is . . . ”), and importance scores for the speech (e.g., probability values such as 0.92, 0.75). The generation unit, based on the timestamp information of the extracted important segments, uses video editing algorithms (e.g., programs calling FFmpeg APIs) to cut out and concatenate the relevant segments to generate highlight videos. For text minutes generation, important speech texts are input to a summarization model (e.g., Transformer-based summarization model) to generate summary text (e.g., “Today's decisions are A, B, and C.”) or full text. When the user inputs a search word (e.g., “decision,” “budget,” etc.), the playback unit refers to the index information of speech text output by the analysis unit and starts video playback from the timestamp just before the word appears. For example, if the word “budget” appears at 15 minutes 23 seconds, playback starts from 15 minutes 18 seconds. The formatting unit automatically formats the minutes data into a specified template according to the user-specified output format (e.g., PDF, Word, HTML, etc.) and outputs the file. This series of processing is realized by a high-dimensional data analysis and automatic editing flow that combines multiple AI models and rule-based processing, unlike conventional manual work (video viewing→note-taking→summarization→editing), resulting in significant improvements in processing speed, accuracy of minutes generation, user search and reusability, data management efficiency, and reduction of communication load, thereby improving computer technology itself. Specific application fields include automatic minutes generation for company meetings, key point extraction for university lectures, automatic summarization for online classes, breaking news summarization for TV news, automatic generation of court records, recording of medical conferences, and automatic organization of class content in educational settings, among many other use cases.

The minutes generation system according to the embodiment comprises a receiving unit, an analysis unit, a generation unit, a playback unit, and a formatting unit. The receiving unit is a section for the user to load videos into the system. For example, the receiving unit allows the user to load recordings of meetings, lectures, classes, etc. into the system. The receiving unit can accept various video formats, such as MP4, AVI, and streaming videos, regardless of the format. The analysis unit is a section that analyzes the video loaded by the receiving unit. The analysis unit analyzes the content of the video and extracts important parts. For example, the analysis unit uses methods such as frame analysis, audio analysis, and text analysis to analyze the content of the video. For meeting recordings, the analysis unit extracts the content of each speaker's remarks and important parts of the discussion. For lecture or class recordings, the analysis unit extracts the instructor's explanations and key points. The generation unit is a section that generates minutes based on the video analyzed by the analysis unit. The generation unit generates two patterns of minutes based on the extracted important parts: highlight video generation and text generation. For example, the generation unit concatenates the extracted important parts to generate a short highlight video. The generation unit also summarizes the extracted important parts as text. The playback unit is a section that plays back the video based on a search word. When the user inputs a search word, the playback unit plays back the video from a few seconds before the word appears. For example, if the user inputs the search word “key point,” the playback unit can play back the video from a few seconds before the word appears. The formatting unit is a section that generates minutes in a specified format. The formatting unit generates minutes in a specific format used for company meetings or in a format used for school classes. For example, the formatting unit generates minutes in formats such as PDF, Word, or HTML. Thus, the minutes generation system according to the embodiment enables the creation of minutes simply by loading a video. Specifically, when the receiving unit accepts a video file (e.g., MP4, AVI, streaming URL, etc.) from the user, it automatically acquires file metadata (e.g., resolution, frame rate, number of audio channels, file size, etc.) and transfers this information to the analysis unit. The analysis unit receives video frame data (e.g., 1920×1080 pixel RGB image tensor, 30 fps, audio waveform data, text data extracted from audio, etc.) as input, and first uses a convolutional neural network (CNN) for image recognition to detect speaker faces and scene transitions, and a recurrent neural network (RNN) or Transformer-based speech recognition model for extracting audio segments and converting speech to text via automatic speech recognition (ASR). Furthermore, a Transformer model for natural language processing (e.g., BERT or a summarization-specialized model) is used to extract important remarks and keywords from the speech text. Input examples include “60-minute meeting video (1920×1080, 30 fps, stereo audio)” and “90-minute lecture video (1280×720, 24 fps, mono audio).” The analysis unit outputs, for these videos, speech segments for each speaker (e.g., with start and end timestamps), text conversion of speech content (e.g., “Today's agenda is . . . ”), and importance scores for the speech (e.g., probability values such as 0.92, 0.75). The generation unit, based on the timestamp information of the extracted important segments, uses video editing algorithms (e.g., programs calling FFmpeg APIs) to cut out and concatenate the relevant segments to generate highlight videos. For text minutes generation, important speech texts are input to a summarization model (e.g., Transformer-based summarization model) to generate summary text (e.g., “Today's decisions are A, B, and C.”) or full text. When the user inputs a search word (e.g., “decision,” “budget,” etc.), the playback unit refers to the index information of speech text output by the analysis unit and starts video playback from the timestamp just before the word appears. For example, if the word “budget” appears at 15 minutes 23 seconds, playback starts from 15 minutes 18 seconds. The formatting unit automatically formats the minutes data into a specified template according to the user-specified output format (e.g., PDF, Word, HTML, etc.) and outputs the file. This series of processing is realized by a high-dimensional data analysis and automatic editing flow that combines multiple AI models and rule-based processing, unlike conventional manual work (video viewing→note-taking→summarization→editing), resulting in significant improvements in processing speed, accuracy of minutes generation, user search and reusability, data management efficiency, and reduction of communication load, thereby improving computer technology itself. Specific application fields include automatic minutes generation for company meetings, key point extraction for university lectures, automatic summarization for online classes, breaking news summarization for TV news, automatic generation of court records, recording of medical conferences, and automatic organization of class content in educational settings, among many other use cases.

A highlight unit configured to generate highlight videos is provided. The highlight unit is a section that extracts important parts and generates highlight videos. For example, the highlight unit generates highlight videos based on methods for extracting important scenes and the specified length of the highlight. The highlight unit can automatically extract important scenes and concatenate them to generate a short highlight video. The highlight unit can also generate highlight videos based on a user-specified length. For example, the highlight unit extracts important scenes based on the specified length and concatenates them to generate a highlight video. Thus, the highlight unit can extract important parts and generate highlight videos. Specifically, the highlight unit receives important segment information from the analysis unit (e.g., a list of importance scores with timestamps, speaker IDs, speech content text, etc.) as input data. The highlight unit first extracts segments where the importance score exceeds a predetermined threshold (e.g., 0.8 or higher), and automatically adds context frames (e.g., 5 seconds before and after) to the extracted segments to facilitate viewer understanding. If the user specifies a length such as “within 5 minutes,” the highlight unit sorts segments by importance score and applies an algorithm (e.g., greedy method or dynamic programming) to automatically select and concatenate segments so that the total time does not exceed the specified value. The highlight unit calls a video editing API (e.g., FFmpeg wrapper) to cut out and concatenate the video and audio data of the specified segments and perform encoding (e.g., H.264/AAC). If the user specifies conditions such as “by speaker” or “by topic,” the highlight unit refers to metadata from the analysis unit (speaker ID, topic tags, etc.) and extracts and edits only segments that meet the conditions. The highlight unit can also automatically generate thumbnail images and superimpose important speech text (subtitle synthesis) on the generated highlight video. As a technical effect, the highlight unit can realize high-speed and high-precision automatic extraction, editing, and encoding of important segments in an integrated manner, greatly reducing the user's editing burden and enabling the generation of videos that allow key points to be grasped in a short time, compared to conventional manual video editing. Application fields include digest creation of key points in meetings and lectures, automatic editing of online learning materials, summary video generation for breaking news, extraction of highlights in sports broadcasts, and extraction of important testimony in court records.

A text unit configured to generate text is provided. The text unit is a section that extracts important parts and generates text. For example, the text unit generates text based on summary text or full text. The text unit can extract important parts and summarize them to generate text. The text unit can also extract important parts and generate full text. For example, the text unit extracts important parts and generates full text. Thus, the text unit can extract important parts and generate text. Specifically, the text unit receives speech text data from the analysis unit (e.g., a list of utterances with timestamps, speaker IDs, importance scores, etc.) as input. For summary text generation, the text unit inputs the extracted important speech text to a Transformer-based summarization model (e.g., BART, T5, etc.) to generate summary text (e.g., “Today's decisions are A, B, and C.”). For full text generation, the text unit concatenates the speech text of important segments in chronological order and automatically formats it into minutes format, adding speaker names and timestamps as needed. If the user specifies an output format such as “summary-focused” or “full text-focused,” the text unit switches between the summarization model and the full text generation module accordingly. The text unit can also automatically perform post-processing such as spelling correction, simplification of expressions, and annotation of technical terms using natural language processing. As a technical effect, the text unit can realize high-speed and high-precision automatic extraction, summarization, and formatting of important speech compared to conventional manual minutes creation, thereby improving the efficiency of minutes creation, comprehensiveness and accuracy of content, and searchability, contributing to improvements in computer technology. Application fields include automatic minutes creation for company meetings, key point text generation for lectures and classes, automatic creation of court records, recording of medical conferences, and automatic organization of class content in educational settings.

A search unit configured to input a search word is provided. The search unit is a section for inputting a search word. For example, the search unit inputs a search word based on keyword search or natural language search. The search unit can input a search word based on a keyword entered by the user. The search unit can also input a search word based on natural language entered by the user. For example, the search unit inputs a search word based on natural language entered by the user. Thus, the search unit can input a search word. Specifically, the search unit receives search queries from the user interface (e.g., word sequences, phrases, natural language sentences, etc.) as input data. For keyword search, the search unit analyzes the entered word sequence as a search word and transfers it to the analysis unit or playback unit. For natural language search, the search unit uses a Transformer-based semantic search model (e.g., Sentence-BERT, etc.) to generate semantic vectors from the input sentence, calculates cosine similarity with speech text and metadata in the video, and identifies the most relevant segments. If the user inputs a natural language sentence such as “I want to see the part about the budget,” the search unit extracts the top segments in semantic vector space and notifies the playback unit of the corresponding timestamps. The search unit can also refer to past search history and user profiles to provide input completion and suggestion functions. As a technical effect, the search unit can realize high-precision search based on semantic relevance, not just simple keyword matching, enabling users to quickly and accurately access the desired information. Application fields include keyword search in meeting minutes, key point search in lecture content, testimony search in court records, case search in medical records, and content search in educational settings.

A control unit configured to control playback of the video is provided. The control unit is a section for controlling playback of the video. For example, the control unit controls playback of the video based on adjustment of playback speed or specification of playback position. The control unit can control playback of the video by adjusting playback speed. The control unit can also control playback of the video by specifying the playback position. For example, the control unit controls playback of the video by specifying the playback position. Thus, the control unit can control playback of the video. Specifically, the control unit receives playback instructions from the user or other units (e.g., playback start timestamp, playback speed multiplier, playback segment specification, etc.) as input data. For playback speed adjustment, the control unit dynamically sets the playback speed parameter of the video player API (e.g., 0.5× speed, 1.5× speed, etc.) and automatically performs pitch correction and lip sync adjustment for audio. For playback position specification, the control unit refers to timestamp information received from the analysis unit and accurately controls playback from the specified position. If the user gives instructions such as “play from 15 minutes 23 seconds” or “play from just before the important remark,” the control unit buffers the video and audio data of the relevant segment and applies an algorithm to speed up seeking (e.g., using keyframe index). Even if the user changes speed or position during playback, the control unit updates playback parameters in real time and maintains synchronization of video and audio. As a technical effect, the control unit can flexibly and accurately respond to various playback needs of users, thereby improving access to important information, enhancing viewing experience, and improving playback control efficiency, contributing to improvements in computer technology. Application fields include playback of key points in meetings and lectures, playback of important parts in breaking news, playback of testimony in court records, playback of cases in medical records, and playback of class content in educational settings.

The receiving unit is configured to estimate a user's emotion and adjust the timing of video reception based on the estimated emotion of the user. The receiving unit is a section that estimates a user's emotion and adjusts the timing of video reception based on the estimated emotion. For example, if the user is feeling stressed, the system automatically delays video reception and waits until the user is relaxed. If the user is relaxed, the system immediately receives the video and smoothly starts processing. Furthermore, if the user is in a hurry, the system quickly receives the video and prioritizes processing. Thus, the receiving unit can adjust the timing of video reception according to the user's emotion. Emotion estimation is realized using, for example, an emotion engine or generative AI with emotion estimation functions. Generative AI may be a text generation AI (e.g., LLM) or a multimodal generative AI, but is not limited to these examples. Some or all of the above-described processing in the receiving unit may be performed using AI or without using AI. For example, the receiving unit can input the user's emotion data to generative AI and have the generative AI perform emotion estimation. Specifically, the receiving unit receives, for emotion estimation, the user's facial image (e.g., face image tensor acquired from a camera, 224×224×3 RGB array), audio waveform data (e.g., 1-second 16 kHz sampled audio vector), and text on the input interface (e.g., natural language sentences such as “I am in a hurry now”) as input data. The receiving unit first preprocesses these multimodal data (normalization, noise removal, face region extraction, etc.), inputs image data to a convolutional neural network (CNN), audio data to a recurrent neural network (RNN) or Transformer-based audio emotion recognition model, and text data to a large language model (LLM). The receiving unit obtains outputs from each model, such as emotion labels (e.g., “stress,” “relaxed,” “in a hurry,” etc.), emotion scores (e.g., stress 0.85, relaxed 0.10, etc. as probability distributions), and feature quantities serving as estimation grounds (e.g., degree of mouth corner droop, pitch variation in voice, expressions of urgency in text, etc.). The receiving unit inputs these output values to a rule-based decision-making module, and performs threshold determination such as “if stress score is 0.8 or higher, delay reception,” “if relaxation score is 0.7 or higher, immediate reception,” “if hurry score is 0.6 or higher, priority reception.” Based on the determination result, the reception timing control module selects delay, immediate, or priority video reception and automatically schedules the reception process. As a technical effect, the receiving unit dynamically optimizes reception timing according to the user's emotional state, thereby improving user experience, system responsiveness, reducing unnecessary stress and waiting time, and improving reception process efficiency, contributing to improvements in computer technology. Unlike conventional simple reception timing control (e.g., immediate reception upon button press), the receiving unit adopts a non-conventional decision-making flow combining high-dimensional multimodal data analysis and AI models, enabling objective and highly reproducible reception control different from human intuitive judgment. Specific application fields include video recording reception in medical settings where stress management is important, educational settings where teaching material video reception is adjusted according to student concentration, optimization of video reception timing to reduce operator burden in call center operations, and video recommendation reception according to user emotion in the entertainment field.

The receiving unit is configured to analyze a user's past video reception history and select an appropriate reception method. The receiving unit is a section that analyzes a user's past video reception history and selects an appropriate reception method. For example, the receiving unit preferentially proposes reception methods frequently used by the user in the past. The receiving unit can also propose the optimal reception method for specific time periods based on the user's past reception history. Furthermore, the receiving unit can analyze the user's past reception history and select the most efficient reception method. Thus, the receiving unit can select an appropriate reception method based on the user's past history. Specifically, the receiving unit maintains a video reception history database for each user (e.g., a structured table including reception date and time, video format, reception method ID, reception duration, user attributes, etc.), and extracts the past N records (e.g., the most recent 100 records) at the time of reception. The receiving unit automatically extracts features from the history data (e.g., selection frequency of reception methods, reception trends by day of week and time period, distribution of reception methods by video genre, etc.), and inputs these as input vectors (e.g., one-hot encoding of categorical variables, time features of time-series data, etc.) to a machine learning model (e.g., decision tree, random forest, or LSTM for time-series prediction). The receiving unit obtains model outputs such as recommendation scores for each reception method (e.g., reception method A: 0.82, reception method B: 0.15, etc. as probability values), reasons for recommendation (e.g., “25 out of the last 30 times were method A”), and predicted reception efficiency (e.g., average duration, error rate, etc.). Based on these output values, the receiving unit highlights recommended reception methods on the user interface to guide the user for easy selection. Furthermore, the receiving unit has an automatic selection mode for reception methods, and if the recommendation score exceeds a predetermined threshold (e.g., 0.7 or higher), it can automatically apply that reception method. As a technical effect, the receiving unit realizes data-driven optimization of reception methods based on the user's past behavior patterns and reception history, thereby improving reception operation efficiency, user satisfaction, reducing reception errors, and distributing processing load across the entire system, contributing to improvements in computer technology. Unlike conventional static selection of reception methods (e.g., selection from a fixed menu), the receiving unit dynamically recommends reception methods through history analysis and AI models, providing an optimized reception experience for each user. Specific application fields include automatic optimization of reception methods in meeting video reception systems within companies, personalized reception flows for class videos in educational institutions, efficiency improvement of case video reception procedures in medical settings, and recommendation of video reception methods according to user preferences in the entertainment field.

The receiving unit is configured to perform filtering at the time of video reception based on the user's current project or field of interest. The receiving unit is a section that performs filtering at the time of video reception based on the user's current project or field of interest. For example, the receiving unit receives only videos related to the project the user is currently working on. The receiving unit can also preferentially receive videos highly relevant to the user's field of interest. Furthermore, the receiving unit can filter out unnecessary videos based on the user's project or field of interest. Thus, the receiving unit can filter videos based on the user's project or field of interest. Specifically, the receiving unit refers to a user profile database (e.g., current project ID, list of interest tags, history of past projects, etc.) and matches it with the metadata of candidate videos for reception (e.g., video title, description, tags, project-related ID, etc.). The receiving unit calculates cosine similarity between the tag vectors of video metadata and user profile, and extracts only videos exceeding a predetermined threshold (e.g., 0.7 or higher) as reception candidates. Furthermore, the receiving unit uses a natural language processing model (e.g., BERT, etc.) to vectorize the video description and the user's field of interest description, and performs filtering based on semantic relevance. The receiving unit displays the filtering results as a list on the user interface, allowing the user to select reception targets. The receiving unit can automatically exclude unnecessary videos (e.g., entertainment videos unrelated to the project) and hide them from the candidate list. As a technical effect, the receiving unit can efficiently receive only videos relevant to the user's work or field of interest, thereby improving reception efficiency, enabling rapid access to highly relevant information, preventing the inclusion of unnecessary data, and improving overall data management efficiency of the system, contributing to improvements in computer technology. Unlike conventional simple video reception (e.g., bulk reception of all videos), the receiving unit performs non-conventional filtering using high-dimensional feature vectors and AI models, providing an optimized reception experience for each user. Specific application fields include project-related video reception in R&D settings, subject-specific teaching material video reception in educational settings, business-related video reception in enterprise knowledge management systems, and case/treatment field-specific video reception in medical settings.

The receiving unit is configured to estimate a user's emotion and determine the priority of videos to be received based on the estimated emotion of the user. The receiving unit is a section that estimates a user's emotion and determines the priority of videos to be received based on the estimated emotion. For example, if the user is feeling stressed, the receiving unit preferentially receives videos with relaxing content. If the user is relaxed, the receiving unit can preferentially receive highly important videos. Furthermore, if the user is in a hurry, the receiving unit can preferentially receive videos that can be viewed in a short time. Thus, the receiving unit can determine the priority of videos to be received according to the user's emotion. Emotion estimation is realized using, for example, an emotion engine or generative AI with emotion estimation functions. Generative AI may be a text generation AI (e.g., LLM) or a multimodal generative AI, but is not limited to these examples. Some or all of the above-described processing in the receiving unit may be performed using AI or without using AI. For example, the receiving unit can input the user's emotion data to generative AI and have the generative AI perform emotion estimation. Specifically, the receiving unit receives, for emotion estimation, facial images (e.g., face image tensor acquired from a camera), audio waveform data (e.g., 1-second 16 kHz audio vector), and input text (e.g., “I am tired today,” etc.) as input data. The receiving unit inputs these data to CNN, RNN, and Transformer-based emotion recognition models, and outputs emotion labels (e.g., “stress,” “relaxed,” “in a hurry,” etc.) and emotion scores (e.g., stress 0.85, etc.). The receiving unit combines video metadata (e.g., video genre, length, content tags, etc.) and emotion labels, and calculates priority scores using rule-based or machine learning models (e.g., decision trees). For example, if the label is “stress,” the priority of videos tagged “relaxation” is increased; if “in a hurry,” the priority of “short videos” is increased. The receiving unit sorts the video list by priority score and presents it on the user interface. As a technical effect, the receiving unit dynamically optimizes the priority of video reception according to the user's emotional state, thereby improving user experience, enabling rapid access to necessary information, reducing unnecessary stress, and improving reception process efficiency, contributing to improvements in computer technology. Unlike conventional static prioritization, the receiving unit adopts a non-conventional priority determination flow combining multimodal emotion estimation and video metadata analysis, providing an optimized reception experience for each user. Specific application fields include reception of stress-relief videos for patients in medical settings, teaching material video reception according to student concentration in educational settings, reception of burden-reducing videos for operators in call center operations, and reception of mood-changing videos in the entertainment field.

The receiving unit is configured to consider the user's geographic location information at the time of video reception and preferentially receive highly relevant videos. The receiving unit is a section that considers the user's geographic location information at the time of video reception and preferentially receives highly relevant videos. For example, the receiving unit preferentially receives videos related to the user's current location. The receiving unit can also preferentially receive videos related to local news or events based on the user's geographic location information. Furthermore, the receiving unit can preferentially receive videos related to travel destinations or business trip locations by considering the user's location information. Thus, the receiving unit can preferentially receive highly relevant videos based on the user's geographic location information. Specifically, the receiving unit receives geographic location information acquired from the user's device (e.g., GPS coordinates, Wi-Fi location estimation, region information based on IP address, etc.) as input data. The receiving unit matches the metadata of candidate videos for reception (e.g., region tags attached to videos, event location information, news occurrence location, etc.) with the user's location information, performs geographic distance calculation (e.g., Haversine distance) and region matching (e.g., matching at the prefecture or municipality level). The receiving unit calculates a location match score (e.g., 0.9=same municipality, 0.7=same prefecture, 0.5=same country, etc.), and extracts videos exceeding a predetermined threshold (e.g., 0.7 or higher) as priority reception candidates. Furthermore, for local news or event videos, the receiving unit compares the event date and time with the user's current time and applies an algorithm to preferentially receive videos just before or after the event. If the user is at a travel or business trip destination, the receiving unit combines past reception history and user profile to automatically extract highly relevant sightseeing or business-related videos. As a technical effect, the receiving unit realizes video reception tailored to the user's current location, enabling rapid access to local information, immediate response to on-site needs in business, learning, or tourism, suppression of unnecessary video reception, and improvement of overall data management efficiency of the system, contributing to improvements in computer technology. Unlike conventional reception without consideration of location information, the receiving unit performs non-conventional reception control by combining high-dimensional location data and video metadata, providing an optimized reception experience for each user. Specific application fields include local news video reception, breaking news video reception at event sites, local information video reception at travel or business trip destinations, and local teaching material video reception in educational settings.

The receiving unit is configured to analyze the user's social media activity at the time of video reception and receive related videos. The receiving unit is a section that analyzes the user's social media activity at the time of video reception and receives related videos. For example, the receiving unit preferentially receives videos related to topics the user has shown interest in on social media. The receiving unit can also analyze the user's social media activity history and propose highly relevant videos. Furthermore, the receiving unit can preferentially receive videos related to accounts or groups followed by the user. Thus, the receiving unit can receive related videos based on the user's social media activity. Specifically, the receiving unit receives activity data acquired from social media APIs with the user's permission (e.g., post content, like history, list of followed accounts, group participation information, etc.) as input data. The receiving unit vectorizes post content and profile information using a natural language processing model (e.g., BERT, etc.), and calculates cosine similarity with the metadata of candidate videos for reception (e.g., title, description, tags, etc.). The receiving unit extracts videos with similarity scores exceeding a predetermined threshold (e.g., 0.7 or higher) as priority reception candidates, and automatically extracts videos related to topics the user has shown interest in (e.g., “AI,” “education,” “medical,” etc.). Furthermore, the receiving unit matches attribute information of followed accounts or groups (e.g., industry, field of expertise, etc.) with video metadata and applies an algorithm to list highly relevant videos. The receiving unit highlights candidate videos for reception on the user interface to guide the user for easy selection. As a technical effect, the receiving unit realizes personalized video reception based on the user's social media activity, enabling rapid access to related information, improving user satisfaction, suppressing unnecessary video reception, and improving overall data management efficiency of the system, contributing to improvements in computer technology. Unlike conventional static video reception, the receiving unit performs non-conventional reception control by combining high-dimensional semantic vectors and social graph analysis, providing an optimized reception experience for each user. Specific application fields include industry-specific news video reception, video reception for specialized community groups, teaching material video reception according to student interests in educational settings, and hobby/preference video reception in the entertainment field.

The analysis unit is configured to estimate a user's emotion and adjust the method of expression in analysis based on the estimated emotion of the user. The analysis unit is a section that estimates a user's emotion and adjusts the method of expression in analysis based on the estimated emotion. For example, if the user is nervous, the analysis unit provides simple and highly visible analysis results. If the user is relaxed, the analysis unit can provide detailed analysis results. Furthermore, if the user is in a hurry, the analysis unit can provide concise analysis results focusing on key points. Thus, the analysis unit can adjust the method of expression in analysis according to the user's emotion. Emotion estimation is realized using, for example, an emotion engine or generative AI with emotion estimation functions. Generative AI may be a text generation AI (e.g., LLM) or a multimodal generative AI, but is not limited to these examples. Some or all of the above-described processing in the analysis unit may be performed using AI or without using AI. For example, the analysis unit can input the user's emotion data to generative AI and have the generative AI perform emotion estimation. Specifically, the analysis unit receives, for emotion estimation, the user's facial image (e.g., 224×224×3 RGB image tensor acquired from a camera), audio waveform data (e.g., 1-second 16 kHz sampled audio vector), and text on the input interface (e.g., natural language sentences such as “I am in a hurry now”) as input data. The analysis unit preprocesses these multimodal data (normalization, noise removal, face region extraction, etc.), inputs image data to a convolutional neural network (CNN), audio data to a recurrent neural network (RNN) or Transformer-based audio emotion recognition model, and text data to a large language model (LLM). The analysis unit obtains outputs from each model, such as emotion labels (e.g., “nervous,” “relaxed,” “in a hurry,” etc.), emotion scores (e.g., nervous 0.80, relaxed 0.15, etc. as probability distributions), and feature quantities serving as estimation grounds (e.g., frown lines, pitch variation in voice, expressions of urgency in text, etc.). The analysis unit inputs these output values to a rule-based decision-making module, and performs threshold determination such as “if nervous score is 0.7 or higher, display simply,” “if relaxation score is 0.7 or higher, display in detail,” “if hurry score is 0.6 or higher, display key points.” Based on the determination result, the analysis unit automatically switches the method of expression in analysis results (e.g., simplified graphs, detailed annotation, bullet points of key points, etc.). Example inputs to AI include “camera image: smiling face image,” “audio: utterance ‘I am relaxed today’,” “text: ‘I am in a hurry.’” Example outputs from AI include “emotion label: relaxed, score 0.85,” “emotion label: in a hurry, score 0.78.” In subsequent processing, the analysis unit branches the UI display mode and explanation text generation algorithm of analysis results according to the emotion estimation result. As a technical effect, the analysis unit dynamically optimizes the method of expression in analysis results according to the user's emotional state, thereby improving user experience, information transmission efficiency, reducing unnecessary information overload and stress, and improving understanding of analysis results, contributing to improvements in computer technology. Unlike conventional static display of analysis results, the analysis unit adopts a non-conventional decision-making flow combining high-dimensional multimodal data analysis and AI models, enabling objective and highly reproducible control of analysis expression different from human intuitive judgment. Specific application fields include display of analysis results for patients in medical settings, teaching material analysis according to student concentration in educational settings, optimization of analysis UI to reduce operator burden in call center operations, and presentation of video analysis results according to user emotion in the entertainment field.

The analysis unit is configured to adjust the level of detail in analysis based on the importance of the video during analysis. The analysis unit is a section that adjusts the level of detail in analysis based on the importance of the video during analysis. For example, the analysis unit performs detailed analysis for highly important videos. The analysis unit can also perform concise analysis for less important videos. Furthermore, the analysis unit can adjust the depth and scope of analysis according to the importance. Thus, the analysis unit can adjust the level of detail in analysis according to the importance of the video. Specifically, the analysis unit receives video metadata from the receiving unit (e.g., video genre, category such as meeting, lecture, news, user-specified importance tag, importance score based on past viewing/usage history, etc.) as input data. The analysis unit performs threshold determination of the importance score (e.g., 0.95=very important, 0.60=somewhat important, 0.30=low importance, etc.), and if the score is high, executes all stages of a multi-stage analysis flow (e.g., image recognition+speech recognition+natural language processing+summarization+keyword extraction+emotion analysis, etc.) and outputs detailed analysis results (e.g., speech content for each speaker, flow of discussion, grounds for important remarks, links to related materials, etc.). If the importance is low, the analysis unit switches to a simplified analysis flow such as extraction of main speech segments and summary of key points only. Example inputs to AI include “video metadata: meeting, importance 0.92,” “video metadata: lecture, importance 0.45,” etc. Example outputs from AI include “detailed analysis result: full text of speaker A's remarks, flow diagram of discussion, keyword list,” “simple analysis result: only 3 lines of key points.” In subsequent processing, the analysis unit automatically switches the data structure passed to the generation unit or playback unit according to the level of detail (e.g., detailed list of utterances with timestamps, summary of key points only, etc.). As a technical effect, the analysis unit optimizes allocation of analysis resources and processing depth according to the importance of the video, thereby enabling efficient use of computational resources, improving analysis accuracy, reducing unnecessary computational load, and flexibly responding to user needs, contributing to improvements in computer technology. Unlike conventional uniform analysis flows, the analysis unit dynamically controls the depth of analysis based on importance scores, providing optimal analysis experiences in various use cases such as business, education, and medical settings.

The analysis unit is configured to apply different analysis algorithms according to the category of the video during analysis. The analysis unit is a section that applies different analysis algorithms according to the category of the video during analysis. For example, the analysis unit applies a speech content analysis algorithm for meeting videos. The analysis unit can also apply an explanation content analysis algorithm for lecture videos. Furthermore, the analysis unit can apply an important news item analysis algorithm for news videos. Thus, the analysis unit can apply different analysis algorithms according to the category of the video. Specifically, the analysis unit receives video metadata from the receiving unit (e.g., category label, title, description, etc.) as input data. Based on category determination (e.g., meeting, lecture, news, medical, education, etc.), the analysis algorithm selection module automatically selects the appropriate analysis pipeline. For example, for meeting videos, the analysis unit combines a face recognition CNN for speaker identification, an RNN for speech segment detection, and a natural language processing model (e.g., BERT-based) for speech content extraction, and performs discussion structure analysis and speaker-by-speaker speech summarization. For lecture videos, the analysis unit applies a scene transition detection algorithm for extracting instructor explanation segments, a technical term extraction model, and a key point summarization model, and performs analysis emphasizing educational elements. For news videos, the analysis unit applies time-series clustering for news item detection, important speech extraction, and emotion analysis models, and performs analysis focusing on timeliness and topicality. Example inputs to AI include “category: meeting,” “category: lecture,” “category: news,” etc. Example outputs from AI include “meeting: list of speaker A's remarks, flow diagram of discussion,” “lecture: list of key points, explanation of technical terms,” “news: list of news items, emotion scores.” In subsequent processing, the analysis unit passes optimized analysis results for each category to the generation unit or playback unit to enhance user experience. As a technical effect, the analysis unit realizes automatic selection and application of optimal analysis algorithms according to video category, thereby improving analysis accuracy, optimizing processing efficiency, flexibly responding to user needs, and enhancing system extensibility, contributing to improvements in computer technology. Unlike conventional uniform application of analysis algorithms, the analysis unit realizes category-specific non-conventional analysis flows, delivering high technical effects in diverse use cases such as business meetings, educational settings, and news organizations.

The analysis unit is configured to estimate a user's emotion and adjust the length of analysis based on the estimated emotion of the user. The analysis unit is a section that estimates a user's emotion and adjusts the length of analysis based on the estimated emotion. For example, if the user is in a hurry, the analysis unit provides a short and concise analysis focusing on key points. If the user is relaxed, the analysis unit can provide detailed analysis. Furthermore, if the user is excited, the analysis unit can provide analysis with visually stimulating effects. Thus, the analysis unit can adjust the length of analysis according to the user's emotion. Emotion estimation is realized using, for example, an emotion engine or generative AI with emotion estimation functions. Generative AI may be a text generation AI (e.g., LLM) or a multimodal generative AI, but is not limited to these examples. Some or all of the above-described processing in the analysis unit may be performed using AI or without using AI. For example, the analysis unit can input the user's emotion data to generative AI and have the generative AI perform emotion estimation. Specifically, the analysis unit receives, for emotion estimation, facial images (e.g., face image tensor acquired from a camera), audio waveform data (e.g., 1-second 16 kHz audio vector), and input text (e.g., “I am tired today,” etc.) as input data. The analysis unit inputs these data to CNN, RNN, and Transformer-based emotion recognition models, and outputs emotion labels (e.g., “in a hurry,” “relaxed,” “excited,” etc.) and emotion scores (e.g., in a hurry 0.85, etc.). Based on the emotion label and score, the analysis unit automatically adjusts the length of analysis results (e.g., only 3 lines of key points, 10 lines of detailed explanation, 5 lines with effects, etc.). Example inputs to AI include “face image: serious expression,” “audio: ‘I am in a hurry,’” “text: ‘I am relaxed today,’” etc. Example outputs from AI include “emotion label: in a hurry, score 0.90,” “emotion label: relaxed, score 0.80,” etc. In subsequent processing, the analysis unit switches the UI display and data transfer method to the generation unit according to the length of analysis results. As a technical effect, the analysis unit dynamically optimizes the length of analysis results according to the user's emotional state, thereby improving user experience, information transmission efficiency, reducing unnecessary information overload and stress, and improving understanding of analysis results, contributing to improvements in computer technology. Unlike conventional static setting of analysis result length, the analysis unit adopts a non-conventional flow combining multimodal emotion estimation and analysis length control, delivering high technical effects in diverse use cases such as medical, educational, and entertainment fields.

The analysis unit is configured to determine the priority of analysis based on the shooting time of the video during analysis. The analysis unit is a section that determines the priority of analysis based on the shooting time of the video during analysis. For example, the analysis unit preferentially analyzes the latest videos. The analysis unit can also determine the priority of analysis for past videos according to their importance. Furthermore, the analysis unit can adjust the order of analysis based on the shooting time. Thus, the analysis unit can determine the priority of analysis based on the shooting time of the video. Specifically, the analysis unit receives video metadata from the receiving unit (e.g., shooting date and time, upload date and time, video ID, etc.) as input data. The analysis unit calculates a priority score based on shooting time information (e.g., latest=1.0, one week ago=0.8, one year ago=0.3, etc.), and preferentially queues the latest videos for analysis. For past videos, the analysis unit dynamically adjusts the order of analysis by combining importance scores and user-specified priority tags. Example inputs to AI include “shooting date: 2024-06-01,” “shooting date: 2023-05-15,” etc. Example outputs from AI include “priority score: 0.95,” “priority score: 0.40,” etc. In subsequent processing, the analysis unit queues analysis jobs in the scheduler according to priority score, optimizing overall system processing efficiency. As a technical effect, the analysis unit realizes priority control of analysis based on shooting time, enabling rapid access to the latest information, ensuring immediacy in business and learning settings, reducing unnecessary delays, and optimizing system resources, contributing to improvements in computer technology. Unlike conventional static setting of analysis order, the analysis unit adopts a non-conventional priority determination flow combining shooting time and importance, delivering high technical effects in diverse use cases such as breaking news, court records, and medical settings.

The analysis unit is configured to adjust the order of analysis based on the relevance of the video during analysis. The analysis unit is a section that adjusts the order of analysis based on the relevance of the video during analysis. For example, the analysis unit preferentially analyzes highly relevant videos. The analysis unit can also lower the priority of analysis for less relevant videos. Furthermore, the analysis unit can adjust the order of analysis according to relevance. Thus, the analysis unit can adjust the order of analysis based on the relevance of the video. Specifically, the analysis unit receives video metadata from the receiving unit (e.g., project ID, tags, description, etc.) and user profile information (e.g., current work content, field of interest, etc.) as input data. The analysis unit calculates cosine similarity between the tag vectors of video metadata and user profile, and calculates a relevance score (e.g., 0.95=high relevance, 0.50=medium relevance, 0.20=low relevance, etc.). The analysis unit preferentially queues highly relevant videos for analysis and postpones less relevant videos. Example inputs to AI include “video tag: AI, education,” “user field of interest: AI,” etc. Example outputs from AI include “relevance score: 0.92,” “relevance score: 0.35,” etc. In subsequent processing, the analysis unit queues analysis jobs in the scheduler according to relevance score, providing analysis results tailored to user needs quickly. As a technical effect, the analysis unit realizes control of analysis order based on relevance, thereby improving work efficiency, user satisfaction, reducing unnecessary computational load, and optimizing system resources, contributing to improvements in computer technology. Unlike conventional static setting of analysis order, the analysis unit adopts a non-conventional relevance determination flow using high-dimensional feature vectors and AI models, delivering high technical effects in diverse use cases such as R&D, education, and medical settings.

The generation unit is configured to estimate a user's emotion and adjust the method of expression in the minutes to be generated based on the estimated emotion of the user. The generation unit is a section that estimates a user's emotion and adjusts the method of expression in the minutes to be generated based on the estimated emotion. For example, if the user is relaxed, the generation unit generates detailed minutes. If the user is in a hurry, the generation unit can generate concise minutes focusing on key points. Furthermore, if the user is excited, the generation unit can generate minutes with visually stimulating effects. Thus, the generation unit can adjust the method of expression in the minutes to be generated according to the user's emotion. Emotion estimation is realized using, for example, an emotion engine or generative AI with emotion estimation functions. Generative AI may be a text generation AI (e.g., LLM) or a multimodal generative AI, but is not limited to these examples. Some or all of the above-described processing in the generation unit may be performed using AI or without using AI. For example, the generation unit can input the user's emotion data to generative AI and have the generative AI perform emotion estimation. Specifically, the generation unit receives emotion estimation results from the receiving unit or analysis unit (e.g., emotion label from facial image, emotion score from audio waveform, emotion classification result from text input, etc.) as input data. Based on these emotion data, the generation unit dynamically switches parameters at each stage of the minutes generation pipeline (summary generation, full text generation, layout formatting, effect application, etc.). For detailed minutes generation, the generation unit inputs extracted important speech text to a Transformer-based summarization model (e.g., BART, T5, etc.), sets the summarization parameter low, and generates a detailed summary with abundant information. For concise minutes generation, the generation unit sets the summarization parameter high and generates a short summary extracting only key points. For visual effect application, the generation unit changes parameters such as layout template, font, color scheme, and animation effects, and automatically applies emphasis and dynamic effects according to the user's excitement level. Example inputs to AI include “emotion label: relaxed, score 0.85,” “emotion label: in a hurry, score 0.90,” “emotion label: excited, score 0.75,” etc. Example outputs from AI include “detailed minutes: full text of each speaker's remarks+flow of discussion+annotated,” “concise minutes: only 3 lines of key points,” “minutes with effects: summary with emphasis color and animation.” After generation, the generation unit transfers these outputs to the formatting unit or playback unit, realizing minutes display and video playback optimized for the user's emotional state. As a technical effect, the generation unit dynamically optimizes the method of expression in the minutes according to the user's emotional state, thereby improving user experience, information transmission efficiency, reducing stress and information overload, and improving understanding of minutes, contributing to improvements in computer technology. Unlike conventional static minutes generation, the generation unit adopts a non-conventional flow combining multimodal emotion estimation and control of minutes generation parameters, enabling objective and highly reproducible minutes generation different from human intuitive judgment. Specific application fields include minutes generation for patients in medical settings, teaching material minutes generation according to student concentration in educational settings, optimization of minutes UI to reduce operator burden in call center operations, and video summary generation according to user emotion in the entertainment field.

The generation unit can adjust the level of detail of the minutes to be generated based on the importance of the video at the time of generation. The generation unit is a section that adjusts the level of detail of the minutes to be generated based on the importance of the video at the time of generation. For example, the generation unit generates detailed minutes for highly important videos. The generation unit can also generate concise minutes for videos of low importance. Furthermore, the generation unit can adjust the level of detail of the minutes according to the importance. Thus, the generation unit can adjust the level of detail of the minutes based on the importance of the video. Specifically, the generation unit receives video metadata (e.g., video genre, category, user-specified importance tag, importance score based on past usage history, etc.) from the analysis unit as input data. The generation unit performs threshold judgment on the importance score (e.g., 0.95=very important, 0.60=somewhat important, 0.30=low importance, etc.), and if the score is high, executes all steps of a multi-stage minutes generation flow (e.g., full-text summary, detailed records for each speaker, discussion flow, annotation, etc.) and outputs detailed minutes (e.g., full text of each speaker's remarks, discussion flow diagram, keyword list, links to related materials, etc.). If the importance is low, the flow switches to a simplified minutes generation process, such as extracting main speech segments and summarizing only the key points. Examples of AI input include “Video metadata: meeting, importance 0.92” and “Video metadata: lecture, importance 0.45”. Examples of AI output include “Detailed minutes: full text of speaker A's remarks, discussion flow diagram, keyword list” and “Concise minutes: only 3 lines of key points”. The generation unit transfers the generated minutes data, according to the level of detail, to the formatting unit or playback unit, thereby realizing optimal minutes display and output according to user needs and system resources. As a technical effect, the generation unit optimizes the allocation of minutes generation resources and processing depth according to the importance of the video, thereby improving the efficient use of computational resources, enhancing the accuracy of minutes generation, reducing unnecessary computational load, and flexibly responding to user needs, thus improving computer technology. Unlike conventional uniform minutes generation flows, the generation unit performs dynamic detail control based on importance scores, enabling optimal minutes generation experiences in various use cases such as business, education, and medical fields.

The generation unit can apply different generation algorithms according to the category of the video at the time of generation. The generation unit is a section that applies different generation algorithms according to the category of the video at the time of generation. For example, the generation unit generates minutes that emphasize the content of remarks for meeting videos. The generation unit can also generate minutes that emphasize the lecturer's explanations for lecture videos. Furthermore, the generation unit can generate minutes that emphasize important news items for news videos. Thus, the generation unit can apply different generation algorithms according to the category of the video. Specifically, the generation unit receives video metadata (e.g., category label, title, description, etc.) from the receiving unit or analysis unit as input data. Based on category determination (e.g., meeting, lecture, news, medical, education, etc.), the generation algorithm selection module automatically selects the appropriate minutes generation pipeline. For example, for meeting videos, a combination of face recognition CNN for speaker identification, voice segment detection RNN, and natural language processing model (e.g., BERT-based) for extracting speech content is used to perform discussion structure analysis and speaker-specific speech summarization, and outputs a list of remarks for each speaker and a discussion flow diagram when generating minutes. For lecture videos, a scene transition detection algorithm for extracting lecturer explanation segments, a technical term extraction model, and a key point summarization model are applied to generate minutes that emphasize educational elements (e.g., key point list with technical term explanations). For news videos, time-series clustering for news item detection, important speech extraction, and sentiment analysis models are applied to generate minutes that emphasize timeliness and topicality (e.g., news item list with sentiment scores). Examples of AI input include “Category: meeting”, “Category: lecture”, “Category: news”. Examples of AI output include “Meeting: list of remarks by speaker A, discussion flow diagram”, “Lecture: key point list, technical term explanations”, “News: news item list, sentiment score”. The generation unit transfers the minutes data optimized for each category to the formatting unit or playback unit to enhance user experience. As a technical effect, the generation unit improves computer technology by automatically selecting and applying the optimal minutes generation algorithm according to the video category, thereby improving the accuracy of minutes generation, optimizing processing efficiency, flexibly responding to user needs, and enhancing the scalability of the entire system. Unlike conventional uniform application of minutes generation algorithms, the generation unit realizes a category-specialized, non-conventional generation flow, thereby demonstrating high technical effects in diverse use cases such as corporate meetings, educational settings, and news organizations.

The generation unit can estimate the user's emotion and adjust the length of the minutes to be generated based on the estimated emotion of the user. The generation unit is a section that estimates the user's emotion and adjusts the length of the minutes to be generated based on the estimated emotion of the user. For example, if the user is in a hurry, the generation unit generates short minutes that focus on the key points. If the user is relaxed, the generation unit can generate detailed minutes. Furthermore, if the user is excited, the generation unit can generate minutes with visually stimulating effects. Thus, the generation unit can adjust the length of the minutes according to the user's emotion. Emotion estimation is realized, for example, by using an emotion engine or a generation AI with emotion estimation functionality. The generation AI may be a text generation AI (e.g., LLM) or a multimodal generation AI, but is not limited to these examples. Some or all of the above-described processing in the generation unit may be performed using AI or without using AI. For example, the generation unit can input the user's emotion data to the generation AI and have the generation AI perform emotion estimation. Specifically, the generation unit receives the user's emotion estimation results (e.g., emotion label from facial image, emotion score from voice waveform, emotion classification result from text input, etc.) from the receiving unit or analysis unit as input data. Based on the emotion label and score, the generation unit automatically adjusts summary parameters, output line count, level of detail, presence of effects, etc., when generating minutes. For example, for the “in a hurry” emotion, the minutes are shortened to only 3 lines of key points; for the “relaxed” emotion, the minutes include detailed explanations in 10 lines; for the “excited” emotion, the minutes include emphasized colors and animations. Examples of AI input include “Emotion label: in a hurry, score 0.90” and “Emotion label: relaxed, score 0.80”. Examples of AI output include “Shortened minutes: 3 lines of key points”, “Detailed minutes: 10 lines of detailed records for each speaker”, “Minutes with effects: emphasized colors and animations”. The generation unit dynamically controls the length and expression method of the minutes to optimize user experience and information transmission efficiency. As a technical effect, the generation unit improves computer technology by dynamically optimizing the length of the minutes according to the user's emotional state, thereby enhancing user experience, improving information transmission efficiency, reducing unnecessary information overload and stress, and improving the understanding of the minutes. Unlike conventional static minutes length settings, the generation unit adopts a non-conventional flow that combines multimodal emotion estimation and minutes length control, thereby demonstrating high technical effects in diverse use cases such as medical, educational, and entertainment fields.

The generation unit can determine the priority of the minutes to be generated based on the shooting time of the video at the time of generation. The generation unit is a section that determines the priority of the minutes to be generated based on the shooting time of the video at the time of generation. For example, the generation unit generates minutes preferentially for the latest videos. The generation unit can also determine the priority of the minutes for past videos according to their importance. Furthermore, the generation unit can adjust the generation order of the minutes based on the shooting time. Thus, the generation unit can determine the priority of the minutes based on the shooting time of the video. Specifically, the generation unit receives video metadata (e.g., shooting date and time, upload date and time, video ID, category, user-specified importance tag, etc.) from the receiving unit or analysis unit as input data. The generation unit calculates a priority score based on the shooting date and time (e.g., latest=1.0, one week ago=0.8, one year ago=0.3, etc.), and preferentially puts the latest videos into the minutes generation queue. For past videos, the generation order is dynamically adjusted in combination with the importance score and user-specified priority tag. Examples of AI input include “Shooting date: 2024-06-01”, “Shooting date: 2023-05-15”, “Video category: meeting”, “Importance tag: high”. Examples of AI output include “Priority score: 0.95”, “Priority score: 0.40”. The generation unit inputs generation jobs into the scheduler in order of priority score to optimize the processing efficiency of the entire system. In subsequent processing, the generation unit automatically switches the data transfer order to the formatting unit or playback unit according to the priority score, enabling users to quickly access the latest information and important minutes. As a technical effect, the generation unit improves computer technology by controlling the priority of minutes generation based on the shooting time of the video, thereby enabling rapid access to the latest information, ensuring immediacy in business and learning environments, reducing unnecessary delays, and optimizing system resources. Unlike conventional static generation order settings, the generation unit adopts a non-conventional priority determination flow that combines shooting time and importance, thereby demonstrating high technical effects in diverse use cases such as news bulletins, court records, and medical fields. Furthermore, as a variation, the generation unit can apply a multidimensional priority determination algorithm that takes into account not only the shooting time but also video usage history, user's field of interest, project progress, etc., thereby providing an optimized minutes generation experience for each user.

The generation unit can adjust the order of the minutes to be generated based on the relevance of the video at the time of generation. The generation unit is a section that adjusts the order of the minutes to be generated based on the relevance of the video at the time of generation. For example, the generation unit generates minutes preferentially for highly relevant videos. The generation unit can also postpone the generation order of minutes for videos with low relevance. Furthermore, the generation unit can adjust the generation order of the minutes according to the relevance. Thus, the generation unit can adjust the order of the minutes based on the relevance of the video. Specifically, the generation unit receives video metadata (e.g., project ID, tags, description, category, etc.) and user profile information (e.g., current work content, field of interest, past usage history, etc.) from the receiving unit or analysis unit as input data. The generation unit calculates the cosine similarity between the tag vectors of the video metadata and the user profile, and computes a relevance score (e.g., 0.95=high relevance, 0.50=medium relevance, 0.20=low relevance, etc.). Videos with high relevance scores are preferentially put into the minutes generation queue, while those with low scores are postponed. Examples of AI input include “Video tags: AI, education”, “User field of interest: AI”, “Project ID: P123”. Examples of AI output include “Relevance score: 0.92”, “Relevance score: 0.35”. The generation unit inputs generation jobs into the scheduler in order of relevance score to quickly provide minutes that meet user needs. In subsequent processing, the generation unit automatically switches the data transfer order to the formatting unit or playback unit according to the relevance score, enabling users to quickly access the information they need. As a technical effect, the generation unit improves computer technology by controlling the order of minutes generation based on the relevance of the video, thereby improving work efficiency, user satisfaction, reducing unnecessary computational load, and optimizing system resources. Unlike conventional static generation order settings, the generation unit adopts a non-conventional relevance determination flow utilizing high-dimensional feature vectors and AI models, thereby demonstrating high technical effects in diverse use cases such as research and development, education, and medical fields. Furthermore, as a variation, the generation unit can apply a multidimensional generation order optimization algorithm that combines relevance score with video importance, shooting time, user's past minutes usage history, etc.

The playback unit can estimate the user's emotion and adjust the timing of playback based on the estimated emotion of the user. The playback unit is a section that estimates the user's emotion and adjusts the timing of playback based on the estimated emotion of the user. For example, if the user is feeling stressed, the playback unit pauses playback and waits until the user relaxes. If the user is relaxed, the playback unit can start playback immediately. Furthermore, if the user is in a hurry, the playback unit can play back quickly and prioritize important parts. Thus, the playback unit can adjust the timing of playback according to the user's emotion. Emotion estimation is realized, for example, by using an emotion engine or a generation AI with emotion estimation functionality. The generation AI may be a text generation AI (e.g., LLM) or a multimodal generation AI, but is not limited to these examples. Some or all of the above-described processing in the playback unit may be performed using AI or without using AI. For example, the playback unit can input the user's emotion data to the generation AI and have the generation AI perform emotion estimation. Specifically, the playback unit receives facial image data (e.g., face image tensor acquired from a camera, 224×224×3 RGB array), voice waveform data (e.g., 1-second 16 kHz sampled voice vector), and text on the input interface (e.g., natural language sentences such as “I'm in a hurry now”) as input data for user emotion estimation. The playback unit preprocesses these multimodal data in the preprocessing unit (e.g., normalization, noise removal, face region extraction), inputs image data to a convolutional neural network (CNN), voice data to a recurrent neural network (RNN) or Transformer-based voice emotion recognition model, and text data to a large language model (LLM). The playback unit obtains output from each model, such as emotion labels (e.g., “stress”, “relax”, “in a hurry”), emotion scores (e.g., stress 0.85, relax 0.10, etc.), and features serving as the basis for estimation (e.g., degree of mouth corner droop, pitch variation in voice, expressions of urgency in text, etc.). The playback unit inputs these output values to a rule-based decision module, and performs threshold judgment such as “pause playback if stress score is 0.8 or higher”, “immediate playback if relax score is 0.7 or higher”, “priority playback of important parts if hurry score is 0.6 or higher”. Based on the judgment result, the playback timing control module selects delay, immediate, or priority playback, and automatically schedules playback processing. Examples of AI input include “Face image: serious expression”, “Voice: ‘I'm in a hurry’”, “Text: ‘I have plenty of time today’”. Examples of AI output include “Emotion label: in a hurry, score 0.90”, “Emotion label: relax, score 0.80”. In subsequent processing, the playback unit branches playback start timing and playback segment selection algorithms according to the emotion estimation result. As a technical effect, the playback unit improves computer technology by dynamically optimizing playback timing according to the user's emotional state, thereby enhancing user experience, improving system responsiveness, reducing unnecessary stress and waiting time, and improving playback processing efficiency. Unlike conventional simple playback timing control (e.g., immediate playback upon button press), the playback unit adopts a non-conventional decision flow combining high-dimensional multimodal data analysis and AI models, enabling objective and highly reproducible playback control different from human intuitive judgment. Specific application fields include video playback in medical settings where stress management is important, playback of educational videos according to students' concentration levels, playback timing optimization for operator load reduction in call center operations, and video recommendation playback according to user emotions in the entertainment field.

The playback unit can adjust the level of detail of playback based on the importance of the video at the time of playback. The playback unit is a section that adjusts the level of detail of playback based on the importance of the video at the time of playback. For example, the playback unit performs detailed playback for highly important videos. The playback unit can also perform concise playback for videos of low importance. Furthermore, the playback unit can adjust the depth and range of playback according to the importance. Thus, the playback unit can adjust the level of detail of playback according to the importance of the video. Specifically, the playback unit receives video metadata (e.g., video genre, category, user-specified importance tag, importance score based on past usage history, etc.) from the receiving unit or analysis unit as input data. The playback unit performs threshold judgment on the importance score (e.g., 0.95=very important, 0.60=somewhat important, 0.30=low importance, etc.), and if the score is high, executes all steps of a multi-stage playback flow (e.g., detailed playback of speech segments, playback of discussion flow, display of links to related materials, etc.) and outputs detailed playback (e.g., playback of full text of each speaker's remarks, playback of discussion flow diagram, display of keyword list, etc.). If the importance is low, the flow switches to a simplified playback process, such as extracting main speech segments and playing back only the key points. Examples of AI input include “Video metadata: meeting, importance 0.92” and “Video metadata: lecture, importance 0.45”. Examples of AI output include “Detailed playback: full text of speaker A's remarks, discussion flow diagram, keyword list” and “Concise playback: only 3 lines of key points”. The playback unit displays the played video data on the user interface according to the level of detail, thereby realizing the optimal playback experience according to user needs and system resources. As a technical effect, the playback unit optimizes the allocation of playback resources and processing depth according to the importance of the video, thereby improving the efficient use of computational resources, enhancing playback accuracy, reducing unnecessary computational load, and flexibly responding to user needs, thus improving computer technology. Unlike conventional uniform playback flows, the playback unit performs dynamic detail control based on importance scores, enabling optimal playback experiences in various use cases such as business, education, and medical fields. Furthermore, as a variation, the playback unit can apply a multidimensional playback detail optimization algorithm that combines importance scores with the user's emotional state and past playback history.

The playback unit can apply different playback algorithms according to the category of the video at the time of playback. The playback unit is a section that applies different playback algorithms according to the category of the video at the time of playback. For example, the playback unit performs playback that emphasizes the content of remarks for meeting videos. The playback unit can also perform playback that emphasizes the lecturer's explanations for lecture videos. Furthermore, the playback unit can perform playback that emphasizes important news items for news videos. Thus, the playback unit can apply different playback algorithms according to the category of the video. Specifically, the playback unit receives video metadata (e.g., category label, title, description, tag, etc.) from the receiving unit or analysis unit as input data. The category determination module analyzes the video metadata and automatically determines which category the video belongs to, such as “meeting”, “lecture”, “news”, “medical”, “education”, etc. For meeting videos, the playback unit refers to structured data obtained from a face recognition CNN for speaker identification, a voice segment detection RNN, and a natural language processing model (e.g., BERT-based) for extracting speech content, and applies an algorithm that highlights speech segments for each speaker on the timeline and prioritizes playback of important remarks. For lecture videos, the playback unit overlays key point lists and technical term explanations obtained from a scene transition detection algorithm for extracting lecturer explanation segments, a technical term extraction model, and a key point summarization model on the playback UI, and centers playback on the lecturer's explanation segments. For news videos, the playback unit prioritizes playback of segments with high timeliness and topicality based on news item lists and sentiment scores obtained from time-series clustering for news item detection, important speech extraction, and sentiment analysis models. Examples of AI input include “Category: meeting, title: 2024 budget meeting”, “Category: lecture, title: AI basics lecture”, “Category: news, title: latest economic news”. Examples of AI output include “Meeting: speaker A's speech segment 10:15-10:45, importance 0.92”, “Lecture: key point segment 15:00-16:30, with technical term list”, “News: breaking news segment 05:00-05:45, sentiment score 0.85”. The playback unit automatically selects the optimal playback algorithm for each category and dynamically switches extraction of playback segments, playback order, and UI display methods. In subsequent processing, the playback unit inputs playback jobs into the scheduler based on playback segment information and importance scores, enabling users to quickly access the information they need. As a technical effect, the playback unit improves computer technology by automatically selecting and applying the optimal playback algorithm according to the video category, thereby improving playback accuracy, optimizing processing efficiency, flexibly responding to user needs, and enhancing the scalability of the entire system. Unlike conventional uniform application of playback algorithms, the playback unit realizes a category-specialized, non-conventional playback flow, thereby demonstrating high technical effects in diverse use cases such as corporate meetings, educational settings, and news organizations.

The playback unit can estimate the user's emotion and adjust the length of playback based on the estimated emotion of the user. The playback unit is a section that estimates the user's emotion and adjusts the length of playback based on the estimated emotion of the user. For example, if the user is in a hurry, the playback unit performs short playback that focuses on the key points. If the user is relaxed, the playback unit can perform detailed playback. Furthermore, if the user is excited, the playback unit can perform playback with visually stimulating effects. Thus, the playback unit can adjust the length of playback according to the user's emotion. Emotion estimation is realized, for example, by using an emotion engine or a generation AI with emotion estimation functionality. The generation AI may be a text generation AI (e.g., LLM) or a multimodal generation AI, but is not limited to these examples. Some or all of the above-described processing in the playback unit may be performed using AI or without using AI. For example, the playback unit can input the user's emotion data to the generation AI and have the generation AI perform emotion estimation. Specifically, the playback unit receives facial image data (e.g., face image tensor acquired from a camera, 224×224×3 RGB array), voice waveform data (e.g., 1-second 16 kHz sampled voice vector), and text on the input interface (e.g., natural language sentences such as “I'm in a hurry now”) as input data for user emotion estimation. The playback unit preprocesses these multimodal data in the preprocessing unit (e.g., normalization, noise removal, face region extraction), inputs image data to a convolutional neural network (CNN), voice data to a recurrent neural network (RNN) or Transformer-based voice emotion recognition model, and text data to a large language model (LLM). The playback unit obtains output from each model, such as emotion labels (e.g., “in a hurry”, “relax”, “excited”), emotion scores (e.g., in a hurry 0.85, relax 0.10, etc.), and features serving as the basis for estimation (e.g., degree of facial tension, pitch variation in voice, expressions of urgency in text, etc.). The playback unit inputs these output values to a rule-based decision module, and automatically adjusts playback length and expression method, such as shortening playback segments to only 3 lines of key points for the “in a hurry” emotion, extending playback to 10 lines of detailed explanations for the “relax” emotion, and performing playback with emphasized colors and animations for the “excited” emotion. Examples of AI input include “Face image: serious expression”, “Voice: ‘I'm in a hurry’”, “Text: ‘I have plenty of time today’”. Examples of AI output include “Emotion label: in a hurry, score 0.90”, “Emotion label: relax, score 0.80”. In subsequent processing, the playback unit inputs playback jobs into the scheduler according to playback length and presence of effects, thereby optimizing user experience and information transmission efficiency. As a technical effect, the playback unit improves computer technology by dynamically optimizing playback length according to the user's emotional state, thereby enhancing user experience, improving information transmission efficiency, reducing unnecessary information overload and stress, and improving understanding of playback content. Unlike conventional static playback length settings, the playback unit adopts a non-conventional flow that combines multimodal emotion estimation and playback length control, thereby demonstrating high technical effects in diverse use cases such as medical, educational, and entertainment fields.

The playback unit can determine the priority of playback based on the shooting time of the video at the time of playback. The playback unit is a section that determines the priority of playback based on the shooting time of the video at the time of playback. For example, the playback unit preferentially plays back the latest videos. The playback unit can also determine the priority of playback for past videos according to their importance. Furthermore, the playback unit can adjust the playback order based on the shooting time. Thus, the playback unit can determine the priority of playback based on the shooting time of the video. Specifically, the playback unit receives video metadata (e.g., shooting date and time, upload date and time, video ID, category, user-specified importance tag, etc.) from the receiving unit or analysis unit as input data. The playback unit calculates a priority score based on the shooting date and time (e.g., latest=1.0, one week ago=0.8, one year ago=0.3, etc.), and preferentially puts the latest videos into the playback queue. For past videos, the playback order is dynamically adjusted in combination with the importance score and user-specified priority tag. Examples of AI input include “Shooting date: 2024-06-01”, “Shooting date: 2023-05-15”, “Video category: meeting”, “Importance tag: high”. Examples of AI output include “Priority score: 0.95”, “Priority score: 0.40”. The playback unit inputs playback jobs into the scheduler in order of priority score to optimize the processing efficiency of the entire system. In subsequent processing, the playback unit automatically switches extraction of playback segments and playback timing according to the priority score, enabling users to quickly access the latest information and important videos. As a technical effect, the playback unit improves computer technology by controlling the priority of playback based on the shooting time of the video, thereby enabling rapid access to the latest information, ensuring immediacy in business and learning environments, reducing unnecessary delays, and optimizing system resources. Unlike conventional static playback order settings, the playback unit adopts a non-conventional priority determination flow that combines shooting time and importance, thereby demonstrating high technical effects in diverse use cases such as news bulletins, court records, and medical fields.

The playback unit can adjust the order of playback based on the relevance of the video at the time of playback. The playback unit is a section that adjusts the order of playback based on the relevance of the video at the time of playback. For example, the playback unit preferentially plays back highly relevant videos. The playback unit can also lower the priority of playback for videos with low relevance. Furthermore, the playback unit can adjust the playback order according to the relevance. Thus, the playback unit can adjust the order of playback based on the relevance of the video. Specifically, the playback unit receives video metadata (e.g., project ID, tags, description, category, etc.) and user profile information (e.g., current work content, field of interest, past usage history, etc.) from the receiving unit or analysis unit as input data. The playback unit calculates the cosine similarity between the tag vectors of the video metadata and the user profile, and computes a relevance score (e.g., 0.95=high relevance, 0.50=medium relevance, 0.20=low relevance, etc.). Videos with high relevance scores are preferentially put into the playback queue, while those with low scores are postponed. Examples of AI input include “Video tags: AI, education”, “User field of interest: AI”, “Project ID: P123”. Examples of AI output include “Relevance score: 0.92”, “Relevance score: 0.35”. The playback unit inputs playback jobs into the scheduler in order of relevance score to quickly provide videos that meet user needs. In subsequent processing, the playback unit automatically switches extraction of playback segments and playback timing according to the relevance score, enabling users to quickly access the information they need. As a technical effect, the playback unit improves computer technology by controlling the order of playback based on the relevance of the video, thereby improving work efficiency, user satisfaction, reducing unnecessary computational load, and optimizing system resources. Unlike conventional static playback order settings, the playback unit adopts a non-conventional relevance determination flow utilizing high-dimensional feature vectors and AI models, thereby demonstrating high technical effects in diverse use cases such as research and development, education, and medical fields.

The formatting unit can estimate the user's emotion and select a format based on the estimated emotion of the user. The formatting unit is a section that estimates the user's emotion and selects a format based on the estimated emotion of the user. For example, if the user is relaxed, the formatting unit selects a detailed format. The formatting unit can also select a concise format if the user is in a hurry. Furthermore, if the user is excited, the formatting unit can select a visually stimulating format. Thus, the formatting unit can select a format according to the user's emotion. Emotion estimation is realized, for example, by using an emotion engine or a generation AI with emotion estimation functionality. The generation AI may be a text generation AI (e.g., LLM) or a multimodal generation AI, but is not limited to these examples. Some or all of the above-described processing in the formatting unit may be performed using AI or without using AI. For example, the formatting unit can input the user's emotion data to the generation AI and have the generation AI perform emotion estimation. Specifically, the formatting unit receives the user's emotion estimation results (e.g., face image tensor acquired from a camera, 224×224×3 RGB array, voice waveform data, natural language text, etc.) from the receiving unit or analysis unit as input data. The formatting unit preprocesses these multimodal data in the preprocessing unit (e.g., normalization, noise removal, face region extraction), inputs image data to a convolutional neural network, voice data to a recurrent neural network or Transformer-based voice emotion recognition model, and text data to a large language model. The formatting unit obtains output from each model, such as emotion labels (e.g., “relax”, “in a hurry”, “excited”), emotion scores (e.g., relax 0.85, in a hurry 0.10, etc.), and features serving as the basis for estimation (e.g., facial relaxation, voice intonation, expressions of urgency in text, etc.). The formatting unit inputs these output values to a rule-based decision module, and automatically selects a format such as a detailed format (e.g., multi-level headings, annotations, insertion of diagrams and tables) for the “relax” emotion, a concise format (e.g., bullet points, short sentences) for the “in a hurry” emotion, and a visually emphasized format with colors and animations for the “excited” emotion. Examples of AI input include “Face image: smiling expression”, “Voice: ‘I have plenty of time today’”, “Text: ‘I'm in a hurry’”. Examples of AI output include “Emotion label: relax, score 0.90”, “Emotion label: in a hurry, score 0.85”. In subsequent processing, the formatting unit notifies the selected format type to the generation unit or playback unit, and dynamically switches the output layout and UI display method of minutes or highlight videos. As a technical effect, the formatting unit improves computer technology by dynamically optimizing format selection according to the user's emotional state, thereby enhancing user experience, improving information transmission efficiency, reducing stress and information overload, and improving understanding of minutes and highlights. Unlike conventional static format selection, the formatting unit adopts a non-conventional flow that combines multimodal emotion estimation and format selection parameter control, enabling objective and highly reproducible format selection different from human intuitive judgment. Specific application fields include format selection for patient minutes in medical settings, switching of educational material formats according to students' concentration levels in educational settings, UI optimization of minutes for operator load reduction in call center operations, and generation of video summary formats according to user emotions in the entertainment field.

The formatting unit can refer to past format usage history to select the optimal format at the time of format selection. The formatting unit is a section that refers to past format usage history to select the optimal format at the time of format selection. For example, the formatting unit preferentially proposes formats that the user has used in the past. The formatting unit can also propose the optimal format for a specific time period based on the user's past usage history. Furthermore, the formatting unit can analyze the user's past usage history and select the most efficient format. Thus, the formatting unit can select the optimal format based on past format usage history. Specifically, the formatting unit maintains a format usage history database for each user (e.g., a structured table including usage date and time, format type, usage scene, required time, user attributes, etc.), and extracts the past N records (e.g., the most recent 100 records) at the time of format selection. The formatting unit automatically extracts features (e.g., format selection frequency, usage trends by day of the week and time period, format distribution by video category, etc.) from the history data, and inputs these as input vectors (e.g., one-hot encoding of categorical variables, time features of time-series data, etc.) to a machine learning model (e.g., decision tree, random forest, LSTM for time-series prediction, etc.). The formatting unit obtains model output such as recommendation scores for each format type (e.g., detailed format 0.82, concise format 0.15, etc.), reasons for recommendation (e.g., “25 out of the last 30 times were detailed format”), and efficiency prediction values (e.g., average required time, error rate, etc.). Based on these output values, the formatting unit highlights the recommended format on the user interface and guides the user to make a selection. Furthermore, the formatting unit has an automatic format selection mode, and if the recommendation score exceeds a predetermined threshold (e.g., 0.7 or higher), the format can be automatically applied. Examples of AI input include “History data: detailed format used 25/30 times”, “Usage time period: weekday morning”, “Video category: meeting”. Examples of AI output include “Recommended format: detailed, score 0.85”, “Recommended format: concise, score 0.10”. In subsequent processing, the formatting unit notifies the selected format type to the generation unit or playback unit, and dynamically switches the output layout and UI display method of minutes or highlight videos. As a technical effect, the formatting unit realizes data-driven format optimization based on the user's past behavior patterns and usage history, thereby improving the efficiency of format selection operations, enhancing user satisfaction, reducing output errors, and distributing processing load across the entire system, thus contributing to improvements in computer technology. Unlike conventional static format selection (e.g., selection from a fixed menu), the formatting unit performs dynamic format recommendation through history analysis and AI models, thereby providing an optimized format experience for each user. Specific application fields include automatic optimization of meeting minutes formats within companies, personalization of educational material formats in educational institutions, efficiency improvement of case record formats in medical settings, and video format recommendation according to user preferences in the entertainment field.

The formatting unit can apply different formats according to the category of the video at the time of format selection. The formatting unit is a section that applies different formats according to the category of the video at the time of format selection. For example, the formatting unit applies a format that emphasizes the content of remarks for meeting videos. The formatting unit can also apply a format that emphasizes the lecturer's explanations for lecture videos. Furthermore, the formatting unit can apply a format that emphasizes important news items for news videos. Thus, the formatting unit can apply different formats according to the category of the video. Specifically, the formatting unit receives video metadata (e.g., category label, title, description, tag, etc.) from the receiving unit or analysis unit as input data. The category determination module analyzes the video metadata and automatically determines which category the video belongs to, such as “meeting”, “lecture”, “news”, “medical”, “education”, etc. For meeting videos, the formatting unit applies a format that emphasizes the list of remarks for each speaker and the discussion flow diagram (e.g., speaker name headings, timeline, highlight of important remarks). For lecture videos, the formatting unit applies an educational format centered on key point lists and technical term explanations (e.g., bullet points of key points, term annotations, insertion of diagrams and tables). For news videos, the formatting unit applies a format that emphasizes timeliness and topicality (e.g., news item list, display of sentiment scores, time-series highlights). Examples of AI input include “Category: meeting”, “Category: lecture”, “Category: news”. Examples of AI output include “Meeting format: speaker-specific list+discussion flow”, “Lecture format: key points+term explanations”, “News format: item list+sentiment score”. In subsequent processing, the formatting unit notifies the format type optimized for each category to the generation unit or playback unit, and dynamically switches the output layout and UI display method of minutes or highlight videos. As a technical effect, the formatting unit improves computer technology by automatically selecting and applying the optimal format according to the video category, thereby improving output accuracy, optimizing processing efficiency, flexibly responding to user needs, and enhancing the scalability of the entire system. Unlike conventional uniform application of formats, the formatting unit realizes a category-specialized, non-conventional format selection flow, thereby demonstrating high technical effects in diverse use cases such as corporate meetings, educational settings, and news organizations.

The formatting unit can estimate the user's emotion and determine the priority of formats based on the estimated emotion of the user. The formatting unit is a section that estimates the user's emotion and determines the priority of formats based on the estimated emotion of the user. For example, if the user is relaxed, the formatting unit preferentially selects a detailed format. The formatting unit can also preferentially select a concise format if the user is in a hurry. Furthermore, if the user is excited, the formatting unit can preferentially select a visually stimulating format. Thus, the formatting unit can determine the priority of formats according to the user's emotion. Emotion estimation is realized, for example, by using an emotion engine or a generation AI with emotion estimation functionality. The generation AI may be a text generation AI (e.g., LLM) or a multimodal generation AI, but is not limited to these examples. Some or all of the above-described processing in the formatting unit may be performed using AI or without using AI. For example, the formatting unit can input the user's emotion data to the generation AI and have the generation AI perform emotion estimation. Specifically, the formatting unit receives the user's emotion estimation results (e.g., face image tensor, voice waveform, natural language text, etc.) from the receiving unit or analysis unit as input data. The formatting unit preprocesses these multimodal data in the preprocessing unit (e.g., normalization, noise removal, face region extraction), inputs image data to a convolutional neural network, voice data to a recurrent neural network or Transformer-based voice emotion recognition model, and text data to a large language model. The formatting unit obtains output from each model, such as emotion labels (e.g., “relax”, “in a hurry”, “excited”), emotion scores (e.g., relax 0.85, in a hurry 0.10, etc.), and features serving as the basis for estimation. The formatting unit inputs these output values to a rule-based decision module, and calculates priority scores for format types according to emotion labels and scores (e.g., detailed 0.90, concise 0.80, effect 0.70, etc.), and lists format candidates in order of priority. Examples of AI input include “Face image: smile”, “Voice: ‘I have plenty of time today’”, “Text: ‘I'm in a hurry’”. Examples of AI output include “Priority format: detailed, score 0.90”, “Priority format: concise, score 0.80”. In subsequent processing, the formatting unit notifies format candidates in order of priority score to the generation unit or playback unit, thereby optimizing user experience and information transmission efficiency. As a technical effect, the formatting unit improves computer technology by dynamically optimizing format priority according to the user's emotional state, thereby enhancing user experience, improving information transmission efficiency, reducing unnecessary information overload and stress, and improving understanding of minutes and highlights. Unlike conventional static format priority settings, the formatting unit adopts a non-conventional flow that combines multimodal emotion estimation and format priority control, thereby demonstrating high technical effects in diverse use cases such as medical, educational, and entertainment fields.

The formatting unit can determine the priority of formats based on the shooting time of the video at the time of format selection. The formatting unit is a section that determines the priority of formats based on the shooting time of the video at the time of format selection. For example, the formatting unit preferentially selects formats for the latest videos. The formatting unit can also determine the priority of formats for past videos according to their importance. Furthermore, the formatting unit can adjust the selection order of formats based on the shooting time. Thus, the formatting unit can determine the priority of formats based on the shooting time of the video. Specifically, the formatting unit receives video metadata (e.g., shooting date and time, upload date and time, video ID, category, user-specified importance tag, etc.) from the receiving unit or analysis unit as input data. The formatting unit calculates a priority score based on the shooting date and time (e.g., latest=1.0, one week ago=0.8, one year ago=0.3, etc.), and preferentially puts the latest videos into the format selection queue. For past videos, the selection order is dynamically adjusted in combination with the importance score and user-specified priority tag. Examples of AI input include “Shooting date: 2024-06-01”, “Shooting date: 2023-05-15”, “Video category: meeting”, “Importance tag: high”. Examples of AI output include “Priority score: 0.95”, “Priority score: 0.40”. The formatting unit inputs format selection jobs into the scheduler in order of priority score to optimize the processing efficiency of the entire system. In subsequent processing, the formatting unit automatically switches the data transfer order to the generation unit or playback unit according to the priority score, enabling users to quickly access the latest information and important minutes. As a technical effect, the formatting unit improves computer technology by controlling the priority of format selection based on the shooting time of the video, thereby enabling rapid access to the latest information, ensuring immediacy in business and learning environments, reducing unnecessary delays, and optimizing system resources. Unlike conventional static selection order settings, the formatting unit adopts a non-conventional priority determination flow that combines shooting time and importance, thereby demonstrating high technical effects in diverse use cases such as news bulletins, court records, and medical fields.

The formatting unit can adjust the order of format selection based on the relevance of the video at the time of format selection. The formatting unit is a section that adjusts the order of format selection based on the relevance of the video at the time of format selection. For example, the formatting unit preferentially selects formats for highly relevant videos. The formatting unit can also postpone the selection order of formats for videos with low relevance. Furthermore, the formatting unit can adjust the selection order of formats according to the relevance. Thus, the formatting unit can adjust the order of format selection based on the relevance of the video. Specifically, the formatting unit receives video metadata (e.g., project ID, tags, description, category, etc.) and user profile information (e.g., current work content, field of interest, past usage history, etc.) from the receiving unit or analysis unit as input data. The formatting unit calculates the cosine similarity between the tag vectors of the video metadata and the user profile, and computes a relevance score (e.g., 0.95=high relevance, 0.50=medium relevance, 0.20=low relevance, etc.). Videos with high relevance scores are preferentially put into the format selection queue, while those with low scores are postponed. Examples of AI input include “Video tags: AI, education”, “User field of interest: AI”, “Project ID: P123”. Examples of AI output include “Relevance score: 0.92”, “Relevance score: 0.35”. The formatting unit inputs format selection jobs into the scheduler in order of relevance score to quickly provide formats that meet user needs. In subsequent processing, the formatting unit automatically switches the data transfer order to the generation unit or playback unit according to the relevance score, enabling users to quickly access the information they need. As a technical effect, the formatting unit improves computer technology by controlling the order of format selection based on the relevance of the video, thereby improving work efficiency, user satisfaction, reducing unnecessary computational load, and optimizing system resources. Unlike conventional static selection order settings, the formatting unit adopts a non-conventional relevance determination flow utilizing high-dimensional feature vectors and AI models, thereby demonstrating high technical effects in diverse use cases such as research and development, education, and medical fields.

The highlight unit can estimate the user's emotion and adjust the method of highlight generation based on the estimated emotion of the user. The highlight unit is a section that estimates the user's emotion and adjusts the method of highlight generation based on the estimated emotion of the user. For example, if the user is relaxed, the highlight unit generates detailed highlights. The highlight unit can also generate concise highlights that focus on key points if the user is in a hurry. Furthermore, if the user is excited, the highlight unit can generate highlights with visually stimulating effects. Thus, the highlight unit can adjust the method of highlight generation according to the user's emotion. Emotion estimation is realized, for example, by using an emotion engine or a generation AI with emotion estimation functionality. The generation AI may be a text generation AI (e.g., LLM) or a multimodal generation AI, but is not limited to these examples. Some or all of the above-described processing in the highlight unit may be performed using AI or without using AI. For example, the highlight unit can input the user's emotion data to the generation AI and have the generation AI perform emotion estimation. Specifically, the highlight unit receives facial image tensor acquired from a camera (e.g., 224×224×3 RGB array), voice waveform data (e.g., 1-second 16 kHz sampled voice vector), and natural language text (e.g., “I have plenty of time today”, “I'm in a hurry”, etc.) as input data for user emotion estimation. The highlight unit preprocesses these multimodal data in the preprocessing unit (e.g., normalization, noise removal, face region extraction), inputs image data to a convolutional neural network, voice data to a recurrent neural network or Transformer-based voice emotion recognition model, and text data to a large language model. The highlight unit obtains output from each model, such as emotion labels (e.g., “relax”, “in a hurry”, “excited”), emotion scores (e.g., relax 0.85, in a hurry 0.10, etc.), and features serving as the basis for estimation (e.g., facial relaxation, voice intonation, expressions of urgency in text, etc.). The highlight unit inputs these output values to a rule-based decision module, and automatically generates detailed highlights (e.g., long highlights covering multiple important segments with annotations) for the “relax” emotion, shortened highlights focusing only on key points (e.g., only 3 segments, total within 30 seconds) for the “in a hurry” emotion, and highlights with emphasized colors and animations for the “excited” emotion. Examples of AI input include “Face image: smiling expression”, “Voice: ‘I have plenty of time today’”, “Text: ‘I'm in a hurry’”. Examples of AI output include “Emotion label: relax, score 0.90”, “Emotion label: in a hurry, score 0.85”. In subsequent processing, the highlight unit notifies the generated highlight type to the playback unit or formatting unit, and dynamically switches the output layout and UI display method of highlight videos. As a technical effect, the highlight unit improves computer technology by dynamically optimizing the method of highlight generation according to the user's emotional state, thereby enhancing user experience, improving information transmission efficiency, reducing stress and information overload, and improving understanding of highlight content. Unlike conventional static highlight generation, the highlight unit adopts a non-conventional flow that combines multimodal emotion estimation and highlight generation parameter control, enabling objective and highly reproducible highlight generation different from human intuitive judgment. Specific application fields include highlight generation for patients in medical settings, highlight generation of educational materials according to students' concentration levels in educational settings, UI optimization of highlights for operator load reduction in call center operations, and generation of video summaries according to user emotions in the entertainment field.

The highlight unit can adjust the level of detail of highlights based on the importance of the video at the time of highlight generation. The highlight unit is a section that adjusts the level of detail of highlights based on the importance of the video at the time of highlight generation. For example, the highlight unit generates detailed highlights for highly important videos. The highlight unit can also generate concise highlights for videos of low importance. Furthermore, the highlight unit can adjust the level of detail of highlights according to the importance. Thus, the highlight unit can adjust the level of detail of highlights based on the importance of the video. Specifically, the highlight unit receives video metadata (e.g., video genre, category, user-specified importance tag, importance score based on past usage history, etc.) from the analysis unit or receiving unit as input data. The highlight unit performs threshold judgment on the importance score (e.g., 0.95=very important, 0.60=somewhat important, 0.30=low importance, etc.), and if the score is high, executes all steps of a multi-stage highlight generation flow (e.g., extraction of multiple important segments, summarization, annotation, links to related materials, etc.) and outputs detailed highlights (e.g., important speech segments for each speaker, discussion flow, keyword list, links to related materials, etc.). If the importance is low, the flow switches to a simplified highlight generation process, such as extracting main speech segments and summarizing only the key points. Examples of AI input include “Video metadata: meeting, importance 0.92” and “Video metadata: lecture, importance 0.45”. Examples of AI output include “Detailed highlight: important segment of speaker A, discussion flow diagram, keyword list” and “Concise highlight: only 3 key segments”. The highlight unit transfers the generated highlight data, according to the level of detail, to the playback unit or formatting unit, thereby realizing optimal highlight display and output according to user needs and system resources. As a technical effect, the highlight unit optimizes the allocation of highlight generation resources and processing depth according to the importance of the video, thereby improving the efficient use of computational resources, enhancing highlight generation accuracy, reducing unnecessary computational load, and flexibly responding to user needs, thus improving computer technology. Unlike conventional uniform highlight generation flows, the highlight unit performs dynamic detail control based on importance scores, enabling optimal highlight generation experiences in various use cases such as business, education, and medical fields.

The highlight unit can apply different highlight generation algorithms according to the category of the video at the time of highlight generation. The highlight unit is a section that applies different highlight generation algorithms according to the category of the video at the time of highlight generation. For example, the highlight unit generates highlights that emphasize the content of remarks for meeting videos. The highlight unit can also generate highlights that emphasize the lecturer's explanations for lecture videos. Furthermore, the highlight unit can generate highlights that emphasize important news items for news videos. Thus, the highlight unit can apply different highlight generation algorithms according to the category of the video. Specifically, the highlight unit receives video metadata (e.g., category label, title, description, tag, etc.) from the receiving unit or analysis unit as input data. The category determination module analyzes the video metadata and automatically determines which category the video belongs to, such as “meeting”, “lecture”, “news”, “medical”, “education”, etc. For meeting videos, the highlight unit refers to structured data obtained from a face recognition CNN for speaker identification, a voice segment detection RNN, and a natural language processing model (e.g., BERT-based) for extracting speech content, and extracts important speech segments for each speaker and generates highlights that visualize the discussion flow. For lecture videos, the highlight unit incorporates key point lists and technical term explanations obtained from a scene transition detection algorithm for extracting lecturer explanation segments, a technical term extraction model, and a key point summarization model into the highlights, and generates highlights that emphasize educational elements. For news videos, the highlight unit prioritizes extraction of segments with high timeliness and topicality based on news item lists and sentiment scores obtained from time-series clustering for news item detection, important speech extraction, and sentiment analysis models, and generates highlights accordingly. Examples of AI input include “Category: meeting”, “Category: lecture”, “Category: news”. Examples of AI output include “Meeting highlight: speaker A's speech segment 10:15-10:45, importance 0.92”, “Lecture highlight: key point segment 15:00-16:30, with technical term list”, “News highlight: breaking news segment 05:00-05:45, sentiment score 0.85”. The highlight unit automatically selects the optimal highlight generation algorithm for each category and dynamically switches extraction and output methods of highlight segments. In subsequent processing, the highlight unit transfers highlight segment information and importance scores to the playback unit or formatting unit, enabling users to quickly access the information they need. As a technical effect, the highlight unit improves computer technology by automatically selecting and applying the optimal highlight generation algorithm according to the video category, thereby improving highlight generation accuracy, optimizing processing efficiency, flexibly responding to user needs, and enhancing the scalability of the entire system. Unlike conventional uniform application of highlight generation algorithms, the highlight unit realizes a category-specialized, non-conventional highlight generation flow, thereby demonstrating high technical effects in diverse use cases such as corporate meetings, educational settings, and news organizations.

The highlight unit is capable of estimating a user's emotion and adjusting the length of the highlight based on the estimated emotion of the user. The highlight unit is a section that estimates the user's emotion and adjusts the length of the highlight based on the estimated emotion. For example, when the user is in a hurry, the highlight unit generates a short highlight that covers only the main points. When the user is relaxed, the highlight unit can generate a detailed highlight. Furthermore, when the user is excited, the highlight unit can generate a highlight with visually stimulating effects. Thus, the highlight unit can adjust the length of the highlight according to the user's emotion. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the highlight unit may be performed using AI or without using AI. For example, the highlight unit may input the user's emotion data to a generative AI and have the generative AI perform emotion estimation. Specifically, the highlight unit receives as input data the user's emotion estimation results (e.g., emotion labels from facial images, emotion scores from audio waveforms, emotion classification results from text input, etc.) received from the receiving unit or analysis unit. The highlight unit automatically adjusts parameters such as the degree of summarization, the number of output segments, the level of detail, and the presence or absence of effects during highlight generation based on the emotion labels and scores. For example, for the emotion “in a hurry,” a short highlight with only the main points in three segments is generated; for the emotion “relaxed,” a long highlight with detailed explanations in ten segments is generated; for the emotion “excited,” a highlight with emphasized colors and animations is generated. Examples of AI input include “emotion label: in a hurry, score 0.90,” “emotion label: relaxed, score 0.80,” etc. Examples of AI output include “shortened highlight: main points in three segments,” “detailed highlight: detailed segments by speaker in ten segments,” “highlight with effects: emphasized colors and animations,” etc. The highlight unit dynamically controls the length and expression method of the highlight to optimize user experience and information transmission efficiency. As a technical effect, the highlight unit improves computer technology by dynamically optimizing the length of the highlight according to the user's emotional state, thereby enhancing user experience, improving information transmission efficiency, reducing unnecessary information overload and stress, and improving understanding of highlight content. Unlike conventional static highlight length settings, the highlight unit adopts a non-conventional flow that combines multimodal emotion estimation and highlight length control, thereby exhibiting high technical effects in various use cases such as medical settings, educational settings, and entertainment fields.

The highlight unit is capable of determining the priority of highlights based on the shooting time of the video during highlight generation. The highlight unit is a section that determines the priority of highlights based on the shooting time of the video during highlight generation. For example, the highlight unit preferentially generates highlights for the latest videos. For past videos, the highlight unit can determine the priority of highlights according to their importance. Furthermore, the highlight unit can adjust the order of highlight generation based on the shooting time. Thus, the highlight unit can determine the priority of highlights based on the shooting time of the video. Specifically, the highlight unit receives as input data video metadata (e.g., shooting date and time, upload date and time, video ID, category, user-specified importance tag, etc.) received from the receiving unit or analysis unit. The highlight unit calculates a priority score (e.g., latest=1.0, one week ago=0.8, one year ago=0.3, etc.) based on the shooting date and time information and preferentially adds the latest videos to the highlight generation queue. For past videos, the highlight unit dynamically adjusts the generation order by combining the importance score and user-specified priority tags. Examples of AI input include “shooting date: 2024-06-01,” “shooting date: 2023-05-15,” “video category: meeting,” “importance tag: high,” etc. Examples of AI output include “priority score: 0.95,” “priority score: 0.40,” etc. The highlight unit submits highlight generation jobs to the scheduler in order of priority score to optimize the overall system processing efficiency. In subsequent processing, the highlight unit automatically switches the data transfer order to the playback unit or formatting unit according to the priority score, enabling users to quickly access the latest information or important highlights. As a technical effect, the highlight unit improves computer technology by controlling the priority of highlight generation based on the shooting time of the video, enabling rapid access to the latest information, ensuring immediacy in business and learning environments, reducing unnecessary delays, and optimizing system-wide resources. Unlike conventional static generation order settings, the highlight unit adopts a non-conventional priority determination flow that combines shooting time and importance, thereby exhibiting high technical effects in various use cases such as news bulletins, court records, and medical settings.

The highlight unit is capable of adjusting the order of highlights based on the relevance of the video during highlight generation. The highlight unit is a section that adjusts the order of highlights based on the relevance of the video during highlight generation. For example, the highlight unit preferentially generates highlights for highly relevant videos. For videos with low relevance, the highlight unit can postpone the order of highlight generation. Furthermore, the highlight unit can adjust the order of highlight generation according to relevance. Thus, the highlight unit can adjust the order of highlights based on the relevance of the video. Specifically, the highlight unit receives as input data video metadata (e.g., project ID, tags, description, category, etc.) and user profile information (e.g., current work content, field of interest, past usage history, etc.) received from the receiving unit or analysis unit. The highlight unit calculates the cosine similarity between the tag vectors of the video metadata and the user profile, and computes a relevance score (e.g., 0.95=high relevance, 0.50=medium relevance, 0.20=low relevance, etc.). Videos with high relevance scores are preferentially added to the highlight generation queue, while videos with low relevance scores are postponed. Examples of AI input include “video tag: AI, education,” “user field of interest: AI,” “project ID: P123,” etc. Examples of AI output include “relevance score: 0.92,” “relevance score: 0.35,” etc. The highlight unit submits highlight generation jobs to the scheduler in order of relevance score, providing highlights that meet user needs quickly. In subsequent processing, the highlight unit automatically switches the data transfer order to the playback unit or formatting unit according to the relevance score, enabling users to quickly access the information they need. As a technical effect, the highlight unit improves computer technology by controlling the order of highlight generation based on the relevance of the video, thereby improving work efficiency, enhancing user satisfaction, reducing unnecessary computational load, and optimizing system-wide resources. Unlike conventional static generation order settings, the highlight unit adopts a non-conventional relevance determination flow utilizing high-dimensional feature vectors and AI models, thereby exhibiting high technical effects in various use cases such as research and development, education, and medical settings.

The text unit is capable of estimating a user's emotion and adjusting the text generation method based on the estimated emotion of the user. The text unit is a section that estimates the user's emotion and adjusts the text generation method based on the estimated emotion. For example, when the user is relaxed, the text unit generates detailed text. When the user is in a hurry, the text unit can generate concise text that covers only the main points. Furthermore, when the user is excited, the text unit can generate text with visually stimulating effects. Thus, the text unit can adjust the text generation method according to the user's emotion. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the text unit may be performed using AI or without using AI. For example, the text unit may input the user's emotion data to a generative AI and have the generative AI perform emotion estimation. Specifically, the text unit receives as input data the user's emotion estimation results (e.g., facial image tensor obtained from a camera (224×224×3 RGB array), audio waveform data (1-second 16 kHz sampled audio vector), natural language text (e.g., “I have plenty of time today,” “I'm in a hurry,” etc.)) received from the receiving unit or analysis unit. The text unit preprocesses these multimodal data in the preprocessing unit by normalization, noise removal, face region extraction, etc., and inputs image data to a convolutional neural network, audio data to a recurrent neural network or Transformer-based speech emotion recognition model, and text data to a large language model, respectively. The text unit obtains as output from each model emotion labels (e.g., “relaxed,” “in a hurry,” “excited,” etc.), emotion scores (e.g., relaxed 0.85, in a hurry 0.10, etc. as probability distributions), and feature quantities serving as the basis for estimation (e.g., relaxed facial expression, intonation of voice, urgency expressions in text, etc.). The text unit inputs these output values to a rule-based decision module and automatically selects detailed text generation parameters (e.g., explanation length 10 lines, with annotations, paragraph structure, etc.) for the “relaxed” emotion, concise text generation parameters (e.g., main points 3 lines, short sentence structure) for the “in a hurry” emotion, and effect text generation parameters with emphasized colors and animations for the “excited” emotion. Examples of AI input include “facial image: smiling expression,” “audio: ‘I have plenty of time today’,” “text: ‘I'm in a hurry’,” etc. Examples of AI output include “emotion label: relaxed, score 0.90,” “emotion label: in a hurry, score 0.85,” etc. The text unit transfers the generated text data to the formatting unit or playback unit to optimize user experience and information transmission efficiency. As a technical effect, the text unit improves computer technology by dynamically optimizing the text generation method according to the user's emotional state, thereby enhancing user experience, improving information transmission efficiency, reducing stress and information overload, and improving understanding of text content. Unlike conventional static text generation, the text unit adopts a non-conventional flow that combines multimodal emotion estimation and text generation parameter control, enabling objective and highly reproducible text generation that differs from human intuitive judgment. Specific application fields include generation of explanatory text for patients in medical settings, generation of educational text according to students' concentration in educational settings, optimization of text UI for reducing operator load in call center operations, and generation of video summary text according to user emotion in the entertainment field, among other diverse use cases.

The text unit is capable of adjusting the level of detail of the text based on the importance of the video during text generation. The text unit is a section that adjusts the level of detail of the text based on the importance of the video during text generation. For example, the text unit generates detailed text for highly important videos. For videos with low importance, the text unit can generate concise text. Furthermore, the text unit can adjust the level of detail of the text according to importance. Thus, the text unit can adjust the level of detail of the text based on the importance of the video. Specifically, the text unit receives as input data video metadata (e.g., video genre, category, user-specified importance tag, importance score based on past usage history, etc.) received from the analysis unit or receiving unit. The text unit determines the threshold for the importance score (e.g., 0.95=very important, 0.60=somewhat important, 0.30=low importance, etc.), and if the score is high, executes all steps of a multi-stage text generation flow (e.g., full summary, detailed record by speaker, discussion flow, annotation, etc.) and outputs detailed text (e.g., full speech by speaker, discussion flow chart, keyword list, related material links, etc.). If the importance is low, the text unit switches to a simplified text generation flow, such as extracting only the main speech segments and summarizing only the main points. Examples of AI input include “video metadata: meeting, importance 0.92,” “video metadata: lecture, importance 0.45,” etc. Examples of AI output include “detailed text: full speech by speaker A, discussion flow chart, keyword list,” “simple text: only three main points,” etc. The text unit transfers the generated text data to the formatting unit or playback unit according to the level of detail, realizing optimal text display and output according to user needs and system resources. As a technical effect, the text unit improves computer technology by optimizing the allocation of text generation resources and processing depth according to the importance of the video, thereby enabling efficient use of computational resources, improving text generation accuracy, reducing unnecessary computational load, and flexibly responding to user needs. Unlike conventional uniform text generation flows, the text unit dynamically controls the level of detail based on the importance score, providing optimal text generation experiences in various use cases such as business, education, and medical settings. Furthermore, as a variation, the text unit can apply a multidimensional text detail optimization algorithm that combines the importance score with the user's emotional state and past text usage history.

The text unit is capable of applying different text generation algorithms according to the category of the video during text generation. The text unit is a section that applies different text generation algorithms according to the category of the video during text generation. For example, for meeting videos, the text unit generates text that emphasizes the content of the speeches. For lecture videos, the text unit can generate text that emphasizes the content of the instructor's explanations. Furthermore, for news videos, the text unit can generate text that emphasizes important news items. Thus, the text unit can apply different text generation algorithms according to the category of the video. Specifically, the text unit receives as input data video metadata (e.g., category label, title, description, tags, etc.) received from the receiving unit or analysis unit. The category determination module of the text unit analyzes the video metadata and automatically determines which category the video belongs to, such as “meeting,” “lecture,” “news,” “medical,” “education,” etc. For meeting videos, the text unit refers to structured data obtained from a face recognition CNN for speaker identification, an RNN for speech segment detection, and a natural language processing model (e.g., BERT-based) for speech content extraction, and generates text that emphasizes speech summaries by speaker and the flow of discussion. For lecture videos, the text unit incorporates key point lists and technical term explanations obtained from scene transition detection algorithms for instructor explanation segment extraction, technical term extraction models, and key point summarization models, and generates text that emphasizes educational elements. For news videos, the text unit generates text with high immediacy and topicality based on news item lists and emotion scores obtained from time-series clustering for news item detection, important speech extraction, and emotion analysis models. Examples of AI input include “category: meeting,” “category: lecture,” “category: news,” etc. Examples of AI output include “meeting text: speaker A's speech list, discussion flow chart,” “lecture text: key point list, technical term explanation,” “news text: news item list, emotion score,” etc. The text unit transfers the optimized text data for each category to the formatting unit or playback unit to enhance user experience. As a technical effect, the text unit improves computer technology by automatically selecting and applying optimal text generation algorithms according to the video category, thereby improving text generation accuracy, optimizing processing efficiency, flexibly responding to user needs, and enhancing system-wide scalability. Unlike conventional uniform application of text generation algorithms, the text unit realizes a category-specific non-conventional generation flow, thereby exhibiting high technical effects in various use cases such as corporate meetings, educational settings, and news organizations.

The text unit is capable of estimating a user's emotion and adjusting the length of the text based on the estimated emotion of the user. The text unit is a section that estimates the user's emotion and adjusts the length of the text based on the estimated emotion. For example, when the user is in a hurry, the text unit generates a short text that covers only the main points. When the user is relaxed, the text unit can generate detailed text. Furthermore, when the user is excited, the text unit can generate text with visually stimulating effects. Thus, the text unit can adjust the length of the text according to the user's emotion. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the text unit may be performed using AI or without using AI. For example, the text unit may input the user's emotion data to a generative AI and have the generative AI perform emotion estimation. Specifically, the text unit receives as input data the user's emotion estimation results (e.g., emotion labels from facial images, emotion scores from audio waveforms, emotion classification results from text input, etc.) received from the receiving unit or analysis unit. The text unit automatically adjusts parameters such as the degree of summarization, number of output lines, level of detail, and presence or absence of effects during text generation based on the emotion labels and scores. For example, for the emotion “in a hurry,” a short text with only the main points in three lines is generated; for the emotion “relaxed,” a detailed text with explanations in ten lines is generated; for the emotion “excited,” a text with emphasized colors and animations is generated. Examples of AI input include “emotion label: in a hurry, score 0.90,” “emotion label: relaxed, score 0.80,” etc. Examples of AI output include “shortened text: main points in three lines,” “detailed text: detailed record by speaker in ten lines,” “text with effects: emphasized colors and animations,” etc. The text unit dynamically controls the length and expression method of the text to optimize user experience and information transmission efficiency. As a technical effect, the text unit improves computer technology by dynamically optimizing the length of the text according to the user's emotional state, thereby enhancing user experience, improving information transmission efficiency, reducing unnecessary information overload and stress, and improving understanding of text content. Unlike conventional static text length settings, the text unit adopts a non-conventional flow that combines multimodal emotion estimation and text length control, thereby exhibiting high technical effects in various use cases such as medical settings, educational settings, and entertainment fields.

The text unit is capable of determining the priority of text based on the shooting time of the video during text generation. The text unit is a section that determines the priority of text based on the shooting time of the video during text generation. For example, the text unit preferentially generates text for the latest videos. For past videos, the text unit can determine the priority of text according to their importance. Furthermore, the text unit can adjust the order of text generation based on the shooting time. Thus, the text unit can determine the priority of text based on the shooting time of the video. Specifically, the text unit receives as input data video metadata (e.g., shooting date and time, upload date and time, video ID, category, user-specified importance tag, etc.) received from the receiving unit or analysis unit. The text unit calculates a priority score (e.g., latest=1.0, one week ago=0.8, one year ago=0.3, etc.) based on the shooting date and time information and preferentially adds the latest videos to the text generation queue. For past videos, the text unit dynamically adjusts the generation order by combining the importance score and user-specified priority tags. Examples of AI input include “shooting date: 2024-06-01,” “shooting date: 2023-05-15,” “video category: meeting,” “importance tag: high,” etc. Examples of AI output include “priority score: 0.95,” “priority score: 0.40,” etc. The text unit submits generation jobs to the scheduler in order of priority score to optimize the overall system processing efficiency. In subsequent processing, the text unit automatically switches the data transfer order to the formatting unit or playback unit according to the priority score, enabling users to quickly access the latest information or important text. As a technical effect, the text unit improves computer technology by controlling the priority of text generation based on the shooting time of the video, enabling rapid access to the latest information, ensuring immediacy in business and learning environments, reducing unnecessary delays, and optimizing system-wide resources. Unlike conventional static generation order settings, the text unit adopts a non-conventional priority determination flow that combines shooting time and importance, thereby exhibiting high technical effects in various use cases such as news bulletins, court records, and medical settings. Furthermore, as a variation, the text unit can apply a multidimensional priority determination algorithm that takes into account not only the shooting time but also video usage history, user field of interest, project progress, and other factors.

The text unit is capable of adjusting the order of text based on the relevance of the video during text generation. The text unit is a section that adjusts the order of text based on the relevance of the video during text generation. For example, the text unit preferentially generates text for highly relevant videos. For videos with low relevance, the text unit can postpone the order of text generation. Furthermore, the text unit can adjust the order of text generation according to relevance. Thus, the text unit can adjust the order of text based on the relevance of the video. Specifically, the text unit receives as input data video metadata (e.g., project ID, tags, description, category, etc.) and user profile information (e.g., current work content, field of interest, past usage history, etc.) received from the receiving unit or analysis unit. The text unit calculates the cosine similarity between the tag vectors of the video metadata and the user profile, and computes a relevance score (e.g., 0.95=high relevance, 0.50=medium relevance, 0.20=low relevance, etc.). Videos with high relevance scores are preferentially added to the text generation queue, while videos with low relevance scores are postponed. Examples of AI input include “video tag: AI, education,” “user field of interest: AI,” “project ID: P123,” etc. Examples of AI output include “relevance score: 0.92,” “relevance score: 0.35,” etc. The text unit submits generation jobs to the scheduler in order of relevance score, providing text that meets user needs quickly. In subsequent processing, the text unit automatically switches the data transfer order to the formatting unit or playback unit according to the relevance score, enabling users to quickly access the information they need. As a technical effect, the text unit improves computer technology by controlling the order of text generation based on the relevance of the video, thereby improving work efficiency, enhancing user satisfaction, reducing unnecessary computational load, and optimizing system-wide resources. Unlike conventional static generation order settings, the text unit adopts a non-conventional relevance determination flow utilizing high-dimensional feature vectors and AI models, thereby exhibiting high technical effects in various use cases such as research and development, education, and medical settings. Furthermore, as a variation, the text unit can apply a multidimensional generation order optimization algorithm that combines the relevance score with the importance, shooting time, and user's past text usage history.

The search unit is capable of estimating a user's emotion and selecting a search word based on the estimated emotion of the user. The search unit is a section that estimates the user's emotion and selects a search word based on the estimated emotion. For example, when the user is relaxed, the search unit proposes detailed search words. When the user is in a hurry, the search unit can propose concise search words. Furthermore, when the user is excited, the search unit can propose visually stimulating search words. Thus, the search unit can select search words according to the user's emotion. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the search unit may be performed using AI or without using AI. For example, the search unit may input the user's emotion data to a generative AI and have the generative AI perform emotion estimation.

The search unit is capable of proposing optimal search words by referring to past search history during searching. The search unit is a section that proposes optimal search words by referring to past search history during searching. For example, the search unit preferentially proposes search words that the user has used in the past. The search unit can also propose optimal search words for specific time periods based on the user's past search history. Furthermore, the search unit can analyze the user's past search history and propose the most efficient search words. Thus, the search unit can propose optimal search words based on past search history.

The search unit is capable of applying different search algorithms according to the category of the video during searching. The search unit is a section that applies different search algorithms according to the category of the video during searching. For example, for meeting videos, the search unit applies a search algorithm that emphasizes the content of the speeches. For lecture videos, the search unit can apply a search algorithm that emphasizes the content of the instructor's explanations. Furthermore, for news videos, the search unit can apply a search algorithm that emphasizes important news items. Thus, the search unit can apply different search algorithms according to the category of the video.

The search unit is capable of estimating a user's emotion and adjusting the display method of search results based on the estimated emotion of the user. The search unit is a section that estimates the user's emotion and adjusts the display method of search results based on the estimated emotion. For example, when the user is relaxed, the search unit displays detailed search results. When the user is in a hurry, the search unit can display concise search results that cover only the main points. Furthermore, when the user is excited, the search unit can display search results with visually stimulating effects. Thus, the search unit can adjust the display method of search results according to the user's emotion. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the search unit may be performed using AI or without using AI. For example, the search unit may input the user's emotion data to a generative AI and have the generative AI perform emotion estimation.

The search unit is capable of determining the priority of search results based on the shooting time of the video during searching. The search unit is a section that determines the priority of search results based on the shooting time of the video during searching. For example, the search unit preferentially displays the latest videos in the search results. For past videos, the search unit can determine the priority of search results according to their importance. Furthermore, the search unit can adjust the display order of search results based on the shooting time. Thus, the search unit can determine the priority of search results based on the shooting time of the video.

The search unit is capable of adjusting the order of search results based on the relevance of the video during searching. The search unit is a section that adjusts the order of search results based on the relevance of the video during searching. For example, the search unit preferentially displays highly relevant videos in the search results. For videos with low relevance, the search unit can postpone the display order of search results. Furthermore, the search unit can adjust the display order of search results according to relevance. Thus, the search unit can adjust the order of search results based on the relevance of the video.

The control unit is capable of estimating a user's emotion and adjusting the playback control method based on the estimated emotion of the user. The control unit is a section that estimates the user's emotion and adjusts the playback control method based on the estimated emotion. For example, when the user is relaxed, the control unit performs detailed playback control. When the user is in a hurry, the control unit can perform concise playback control. Furthermore, when the user is excited, the control unit can perform playback control with visually stimulating effects. Thus, the control unit can adjust the playback control method according to the user's emotion. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the control unit may be performed using AI or without using AI. For example, the control unit may input the user's emotion data to a generative AI and have the generative AI perform emotion estimation.

The control unit is capable of adjusting the level of detail of playback based on the importance of the video during playback control. The control unit is a section that adjusts the level of detail of playback based on the importance of the video during playback control. For example, the control unit performs detailed playback control for highly important videos. For videos with low importance, the control unit can perform concise playback control. Furthermore, the control unit can adjust the depth and range of playback control according to importance. Thus, the control unit can adjust the level of detail of playback based on the importance of the video.

The control unit is capable of applying different playback control algorithms according to the category of the video during playback control. The control unit is a section that applies different playback control algorithms according to the category of the video during playback control. For example, for meeting videos, the control unit performs playback control that emphasizes the content of the speeches. For lecture videos, the control unit can perform playback control that emphasizes the content of the instructor's explanations. Furthermore, for news videos, the control unit can perform playback control that emphasizes important news items. Thus, the control unit can apply different playback control algorithms according to the category of the video.

The control unit is capable of estimating a user's emotion and adjusting the timing of playback control based on the estimated emotion of the user. The control unit is a section that estimates the user's emotion and adjusts the timing of playback control based on the estimated emotion. For example, when the user is relaxed, the control unit sets detailed playback control timing. When the user is in a hurry, the control unit can set concise playback control timing. Furthermore, when the user is excited, the control unit can set playback control timing with visually stimulating effects. Thus, the control unit can adjust the timing of playback control according to the user's emotion. Emotion estimation is realized, for example, by using an emotion engine or a generative AI with emotion estimation functionality. The generative AI may be a text generation AI (e.g., LLM) or a multimodal generative AI, but is not limited to these examples. Some or all of the above-described processing in the control unit may be performed using AI or without using AI. For example, the control unit may input the user's emotion data to a generative AI and have the generative AI perform emotion estimation.

The control unit is capable of determining the priority of playback based on the shooting time of the video during playback control. The control unit is a section that determines the priority of playback based on the shooting time of the video during playback control. For example, the control unit preferentially performs playback control for the latest videos. For past videos, the control unit can determine the priority of playback control according to their importance. Furthermore, the control unit can adjust the order of playback control based on the shooting time. Thus, the control unit can determine the priority of playback based on the shooting time of the video.

The control unit can adjust the order of playback based on the relevance of the videos during playback control. The control unit is a section that adjusts the order of playback based on the relevance of the videos during playback control. For example, the control unit preferentially controls playback of highly relevant videos. In addition, the control unit can lower the priority of playback control for videos with low relevance. Furthermore, the control unit can adjust the order of playback control according to relevance. Thus, the control unit can adjust the order of playback based on the relevance of the videos.

The system according to the embodiment is not limited to the examples described above, and various modifications are possible, for example, as follows.

The receiving unit can analyze a user's past video viewing history and propose an optimal video reception method. For example, the receiving unit preferentially receives highly relevant videos based on the genre and content of videos previously viewed by the user. In addition, the receiving unit can propose an optimal video reception method for a specific time period based on the user's viewing history. Furthermore, the receiving unit can analyze the user's viewing history and select the most efficient video reception method. Thus, the receiving unit can propose an optimal video reception method based on the user's past viewing history.

The analysis unit can estimate a user's emotion and determine the priority of analysis based on the estimated emotion of the user. For example, if the user is feeling stressed, the analysis unit preferentially analyzes videos with relaxing content. If the user is relaxed, the analysis unit can also preferentially analyze videos of high importance. Furthermore, if the user is in a hurry, the analysis unit can preferentially analyze videos that can be analyzed in a short time. Thus, the analysis unit can determine the priority of analysis according to the user's emotion.

The generation unit can refer to a user's past minutes usage history and select an optimal generation method for the minutes to be generated. For example, the generation unit generates minutes in a highly relevant format based on the format and content of minutes previously used by the user. In addition, the generation unit can propose an optimal minutes generation method for a specific time period based on the user's usage history. Furthermore, the generation unit can analyze the user's usage history and select the most efficient minutes generation method. Thus, the generation unit can select an optimal minutes generation method based on the user's past usage history.

The playback unit can estimate a user's emotion and adjust the playback speed based on the estimated emotion of the user. For example, if the user is relaxed, the playback unit plays back at a normal speed. If the user is in a hurry, the playback unit can also play back at a faster speed. Furthermore, if the user is excited, the playback unit can play back at a slower speed. Thus, the playback unit can adjust the playback speed according to the user's emotion.

The formatting unit can estimate a user's emotion and customize the format based on the estimated emotion of the user. For example, if the user is relaxed, the formatting unit provides a detailed format. If the user is in a hurry, the formatting unit can also provide a concise format. Furthermore, if the user is excited, the formatting unit can provide a visually stimulating format. Thus, the formatting unit can customize the format according to the user's emotion.

The highlight unit can analyze a user's past highlight viewing history and propose an optimal highlight generation method. For example, the highlight unit generates highly relevant highlights based on the content and format of highlights previously viewed by the user. In addition, the highlight unit can propose an optimal highlight generation method for a specific time period based on the user's viewing history. Furthermore, the highlight unit can analyze the user's viewing history and select the most efficient highlight generation method. Thus, the highlight unit can propose an optimal highlight generation method based on the user's past viewing history.

The text unit can estimate a user's emotion and adjust the font and color of the text based on the estimated emotion of the user. For example, if the user is relaxed, the text unit uses a font with calm colors. If the user is in a hurry, the text unit can also use a highly visible font. Furthermore, if the user is excited, the text unit can use a font with visually stimulating colors. Thus, the text unit can adjust the font and color of the text according to the user's emotion.

The search unit can analyze a user's past search history and propose an optimal search algorithm. For example, the search unit applies a highly relevant search algorithm based on search words previously used by the user. In addition, the search unit can propose an optimal search algorithm for a specific time period based on the user's search history. Furthermore, the search unit can analyze the user's search history and select the most efficient search algorithm. Thus, the search unit can propose an optimal search algorithm based on the user's past search history.

The control unit can estimate a user's emotion and adjust the playback volume based on the estimated emotion of the user. For example, if the user is relaxed, the control unit plays back at a normal volume. If the user is in a hurry, the control unit can also play back at a higher volume. Furthermore, if the user is excited, the control unit can play back at a lower volume. Thus, the control unit can adjust the playback volume according to the user's emotion.

The receiving unit can consider the user's geographic location information and preferentially receive related videos. For example, the receiving unit preferentially receives videos related to the user's current location. In addition, the receiving unit can preferentially receive videos related to local news or events based on the user's geographic location information. Furthermore, the receiving unit can preferentially receive videos related to travel destinations or business trip locations by considering the user's location information. Thus, the receiving unit can preferentially receive related videos based on the user's geographic location information.

The following is a brief description of the processing flow of Example of the Embodiment.
Step 1: The receiving unit is a section for allowing a user to load a video into the system. For example, the receiving unit allows a user to load recordings of meetings, lectures, classes, and the like into the system. The receiving unit can accept videos in any format, such as MP4, AVI, streaming videos, and so on.
Step 2: The analysis unit is a section for analyzing the video loaded by the receiving unit. The analysis unit analyzes the content of the video and extracts important parts. For example, the analysis unit analyzes the content of the video using methods such as frame analysis, audio analysis, and text analysis. If the video is a recording of a meeting, the analysis unit extracts the content of the speaker's remarks and important discussion points. If the video is a recording of a lecture or class, the analysis unit extracts the instructor's explanations and important points.
Step 3: The generation unit is a section for generating minutes based on the video analyzed by the analysis unit. The generation unit generates two types of minutes: highlight video generation and text generation, based on the extracted important parts. For example, the generation unit generates a short highlight video by connecting the extracted important parts. The generation unit also summarizes the extracted important parts as text.
Step 4: The playback unit is a section for playing back the video based on a search word. When a user inputs a search word, the playback unit plays back the video from a few seconds before the word appears. For example, when a user inputs the search word “important point,” the playback unit can play back the video from a few seconds before the word appears.
Step 5: The formatting unit is a section for generating minutes in a specified format. The formatting unit generates minutes in a specific format used for company meetings or in a specific format used for school classes. For example, the formatting unit generates minutes in formats such as PDF, Word, HTML, and so on.

The specific processing unit 290 sends the results of specific processing to the smart device 14. In the smart device 14, the control unit 46A causes the output device 40 to output the results of specific processing. The microphone 38B acquires voice indicating user input in response to the results of specific processing. The control unit 46A sends the voice data indicating user input acquired by the microphone 38B to the data processing device 12. In the data processing device 12, the specific processing unit 290 acquires the voice data.

The data generation model 58 is a so-called generative AI (Artificial Intelligence). An example of the data generation model 58 is a generative AI such as ChatGPT (registered trademark) (Internet search <URL: https://openai.com/blog/chatgpt>). The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

Moreover, the processing by the data processing system 10 described above is executed by the specific processing unit 290 of the data processing device 12 or the control unit 46A of the smart device 14, but it may be executed by both the specific processing unit 290 of the data processing device 12 and the control unit 46A of the smart device 14. Additionally, the specific processing unit 290 of the data processing device 12 acquires or collects necessary information for processing from the smart device 14 or external devices, and the smart device 14 acquires or collects necessary information for processing from the data processing device 12 or external devices.

Each of the plurality of elements including the aforementioned receiving unit, analysis unit, generation unit, playback unit, and formatting unit is implemented, for example, by at least one of the smart device 14 and the data processing device 12. For example, the receiving unit is implemented by a control unit 46A of the smart device 14, allowing a user to load a video. The analysis unit is implemented, for example, by a specific processing unit 290 of the data processing device 12, and analyzes the content of the video to extract important parts. The generation unit is implemented, for example, by the control unit 46A of the smart device 14, and generates highlight videos and text minutes. The playback unit is implemented, for example, by the specific processing unit 290 of the data processing device 12, and plays back the video based on a search word. The formatting unit is implemented, for example, by the control unit 46A of the smart device 14, and generates minutes in a specified format. The correspondence between each unit and the device or control unit is not limited to the examples described above, and various modifications are possible.

### Second Embodiment

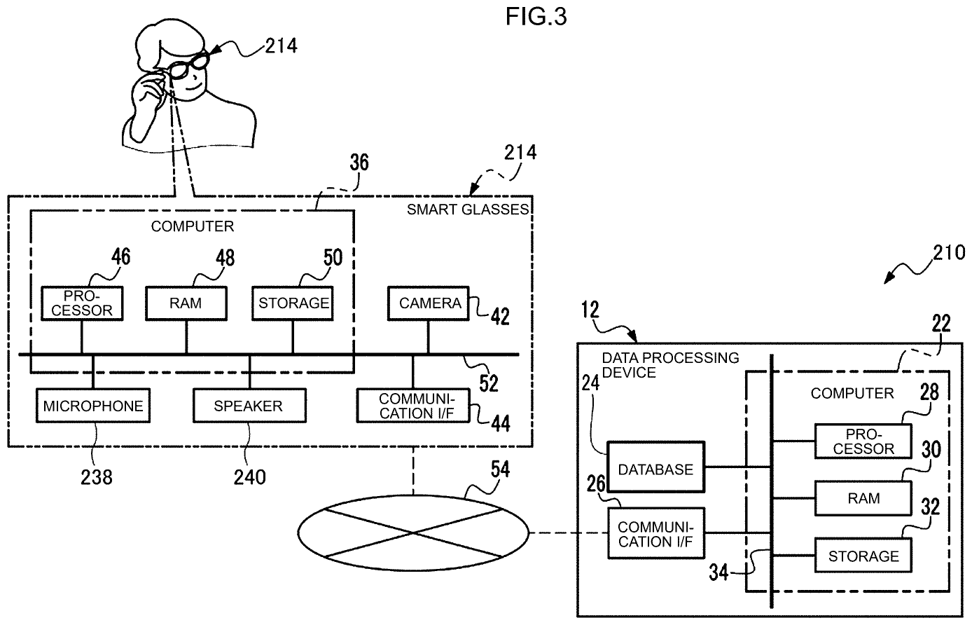

FIG. 3 shows an example configuration of a data processing system 210 according to the second embodiment.

As shown in FIG. 3, the data processing system 210 comprises a data processing device 12 and smart glasses 214. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The smart glasses 214 comprise a computer 36, a microphone 238, a speaker 240, a camera 42, and a communication I/F 44. The computer 36 comprises a processor 46, RAM 48, and storage 50. The processor 46, RAM 48, and storage 50 are connected to a bus 52. The microphone 238, speaker 240, and camera 42 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

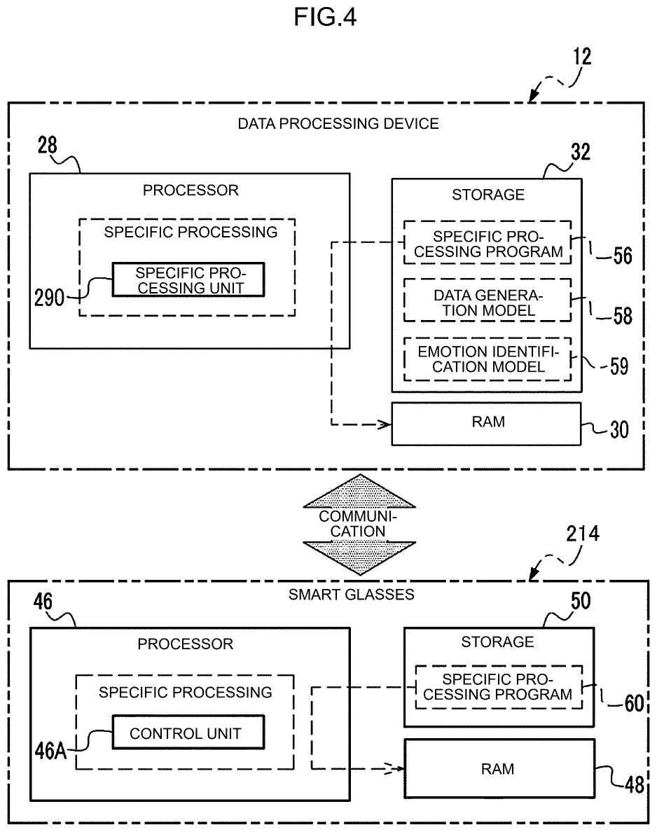

FIG. 4 shows an example of the main functions of the data processing device 12 and smart glasses 214. As shown in FIG. 4, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the smart glasses 214, specific processing is performed by the processor 46. The storage 50 stores a specific processing program 60. The processor 46 reads the specific processing program 60 from the storage 50 and executes it on the RAM 48. The specific processing is realized by the processor 46 operating as a control unit 46A according to the specific processing program 60 executed on the RAM 48. The smart glasses 214 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the smart glasses 214. In the smart glasses 214, the control unit 46A causes the speaker 240 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 210 according to the second embodiment performs the same processing as the data processing system 10 according to the first embodiment. The processing by the data processing system 210 is executed by the specific processing unit 290 of the data processing device 12 or the control unit 46A of the smart glasses 214, but it may be executed by both the specific processing unit 290 of the data processing device 12 and the control unit 46A of the smart glasses 214. Additionally, the specific processing unit 290 of the data processing device 12 acquires or collects necessary information for processing from the smart glasses 214 or external devices, and the smart glasses 214 acquires or collects necessary information for processing from the data processing device 12 or external devices.

Each of the plurality of elements including the aforementioned receiving unit, analysis unit, generation unit, playback unit, and formatting unit is implemented, for example, by at least one of the smart glasses 214 and the data processing device 12. For example, the receiving unit is implemented by a control unit 46A of the smart glasses 214, allowing a user to load a video. The analysis unit is implemented, for example, by a specific processing unit 290 of the data processing device 12, and analyzes the content of the video to extract important parts. The generation unit is implemented, for example, by the control unit 46A of the smart glasses 214, and generates highlight videos and text minutes. The playback unit is implemented, for example, by the specific processing unit 290 of the data processing device 12, and plays back the video based on a search word. The formatting unit is implemented, for example, by the control unit 46A of the smart glasses 214, and generates minutes in a specified format. The correspondence between each unit and the device or control unit is not limited to the examples described above, and various modifications are possible.

### Third Embodiment

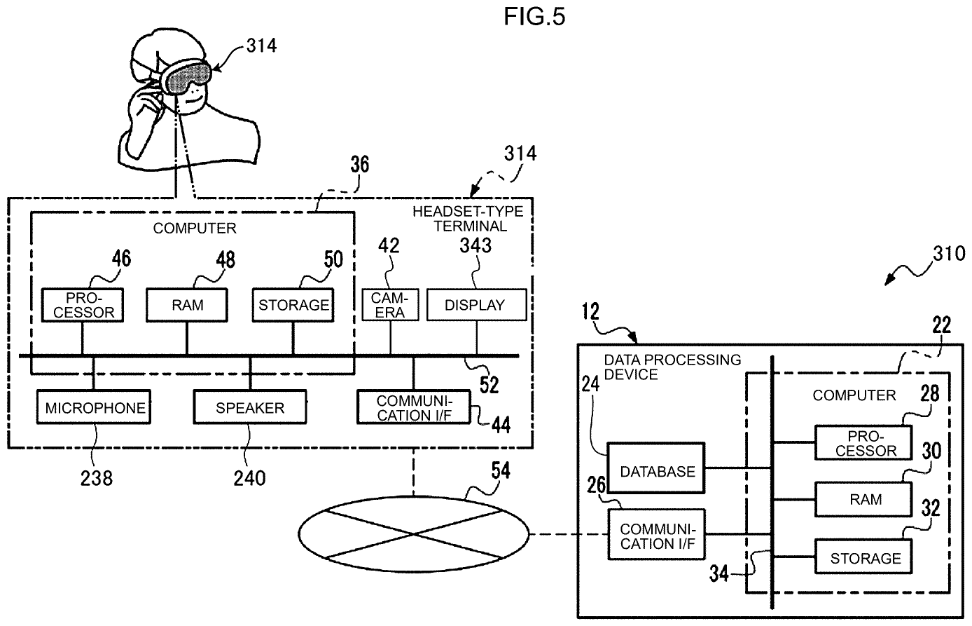

FIG. 5 shows an example configuration of a data processing system 310 according to the third embodiment.

As shown in FIG. 5, the data processing system 310 comprises a data processing device 12 and a headset-type terminal 314. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The headset-type terminal 314 comprises a computer 36, a microphone 238, a speaker 240, a camera 42, a communication I/F 44, and a display 343. The computer 36 comprises a processor 46, RAM 48, and storage 50. The processor 46, RAM 48, and storage 50 are connected to a bus 52. The microphone 238, speaker 240, camera 42, and display 343 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS (Complementary Metal-Oxide-Semiconductor) image sensors or CCD (Charge Coupled Device) image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

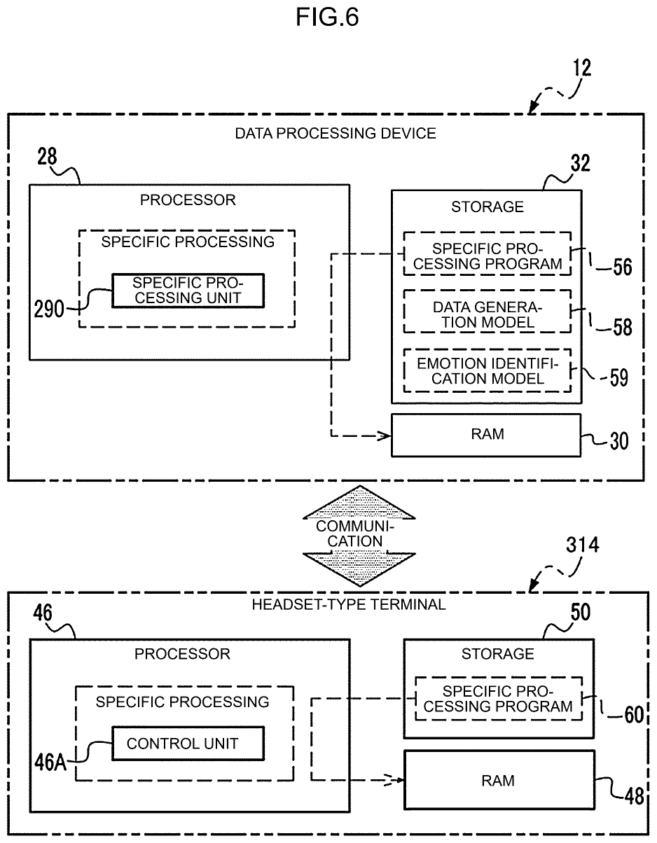

FIG. 6 shows an example of the main functions of the data processing device 12 and the headset-type terminal 314. As shown in FIG. 6, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the headset-type terminal 314, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The headset-type terminal 314 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the headset-type terminal 314. In the headset-type terminal 314, the control unit 46A causes the speaker 240 and the display 343 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 310 according to the third embodiment performs the same processing as the data processing system 10 according to the first embodiment. The processing by the data processing system 310 is executed by the specific processing unit 290 of the data processing device 12 or the control unit 46A of the headset-type terminal 314, but it may be executed by both the specific processing unit 290 of the data processing device 12 and the control unit 46A of the headset-type terminal 314. Additionally, the specific processing unit 290 of the data processing device 12 acquires or collects necessary information for processing from the headset-type terminal 314 or external devices, and the headset-type terminal 314 acquires or collects necessary information for processing from the data processing device 12 or external devices.

Each of the plurality of elements including the aforementioned receiving unit, analysis unit, generation unit, playback unit, and formatting unit is implemented, for example, by at least one of the headset-type terminal 314 and the data processing device 12. For example, the receiving unit is implemented by a control unit 46A of the headset-type terminal 314, allowing a user to load a video. The analysis unit is implemented, for example, by a specific processing unit 290 of the data processing device 12, and analyzes the content of the video to extract important parts. The generation unit is implemented, for example, by the control unit 46A of the headset-type terminal 314, and generates highlight videos and text minutes. The playback unit is implemented, for example, by the specific processing unit 290 of the data processing device 12, and plays back the video based on a search word. The formatting unit is implemented, for example, by the control unit 46A of the headset-type terminal 314, and generates minutes in a specified format. The correspondence between each unit and the device or control unit is not limited to the examples described above, and various modifications are possible.

### Fourth Embodiment

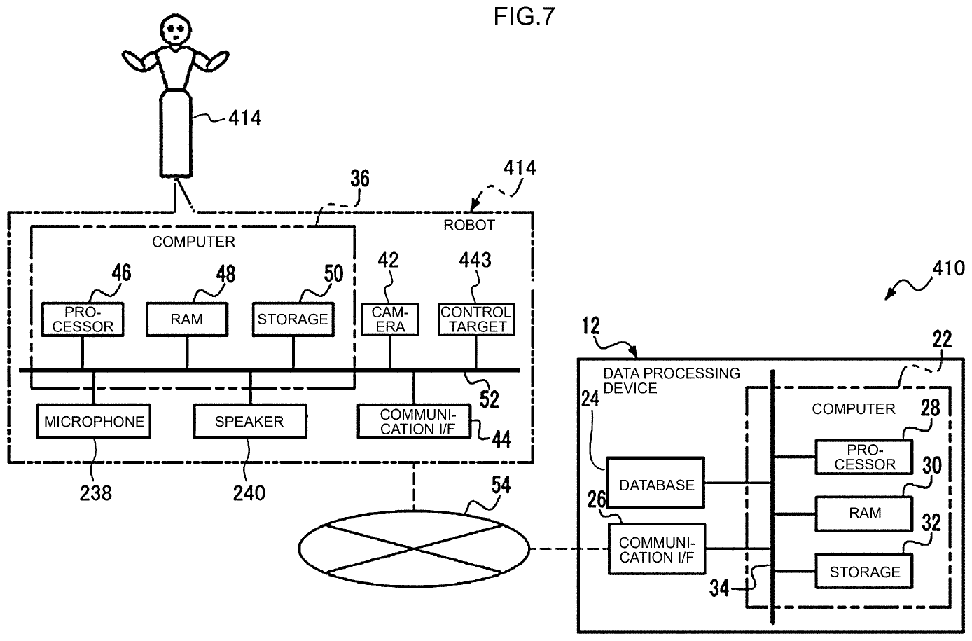

FIG. 7 shows an example configuration of a data processing system 410 according to the fourth embodiment.

As shown in FIG. 7, the data processing system 410 comprises a data processing device 12 and a robot 414. An example of the data processing device 12 is a server.

The data processing device 12 comprises a computer 22, a database 24, and a communication I/F 26. The computer 22 comprises a processor 28, RAM 30, and storage 32. The processor 28, RAM 30, and storage 32 are connected to a bus 34. Additionally, the database 24 and communication I/F 26 are also connected to the bus 34. The communication I/F 26 is connected to a network 54. Examples of the network 54 include a WAN and/or a LAN, among others.

The robot 414 comprises a computer 36, a microphone 238, a speaker 240, a camera 42, a communication I/F 44, and a control target 443. The computer 36 comprises a processor 46, RAM 48, and storage 50. The processor 46, RAM 48, and storage 50 are connected to a bus 52. The microphone 238, speaker 240, camera 42, and control target 443 are also connected to the bus 52.

The microphone 238 accepts voice from the user, accepting instructions, among others, from the user. The microphone 238 captures the voice emitted by the user, converts the captured voice into voice data, and outputs it to the processor 46. The speaker 240 outputs sound according to instructions from the processor 46.

The camera 42 is a small digital camera equipped with optical systems such as lenses, apertures, and shutters, as well as imaging elements such as CMOS image sensors or CCD image sensors, and captures the surroundings of the user (e.g., an imaging range defined by an angle of view equivalent to the typical field of view of a healthy person).

The communication I/F 44 is connected to the network 54. The communication I/F 44 and 26 manage the exchange of various information between the processor 46 and the processor 28 via the network 54. The exchange of various information between the processor 46 and the processor 28 using the communication I/F 44 and 26 is conducted securely.

The control target 443 includes a display device, LEDs for the eyes, and motors for driving arms, hands, and feet, among others. The posture and gestures of the robot 414 are controlled by controlling the motors for the arms, hands, and feet, among others. Some emotions of the robot 414 can be expressed by controlling these motors. Additionally, the expression of the robot 414 can be expressed by controlling the lighting state of the LEDs for the eyes of the robot 414.

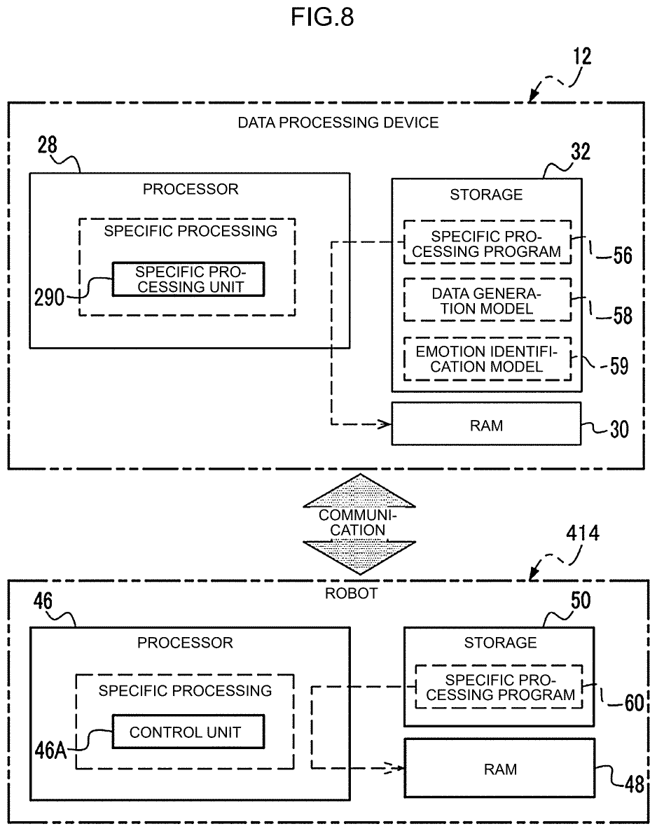

FIG. 8 shows an example of the main functions of the data processing device 12 and the robot 414. As shown in FIG. 8, specific processing is performed in the data processing device 12 by the processor 28. The storage 32 stores a specific processing program 56.

The processor 28 reads the specific processing program 56 from the storage 32 and executes it on the RAM 30. The specific processing is realized by the processor 28 operating as a specific processing unit 290 according to the specific processing program 56 executed on the RAM 30.

The storage 32 stores a data generation model 58 and an emotion identification model 59. The data generation model 58 and emotion identification model 59 are used by the specific processing unit 290. The specific processing unit 290 can estimate the user's emotions using the emotion identification model 59 and perform specific processing using the user's emotions. The emotion estimation function (emotion identification function) using the emotion identification model 59 includes estimating and predicting the user's emotions, but is not limited to such examples. Furthermore, emotion estimation and prediction may include, for example, emotion analysis.

In the robot 414, specific processing is performed by the processor 46. The storage 50 stores a specific program 60. The processor 46 reads the specific program 60 from the storage 50 and executes it on the RAM 48. The specific processing is realized by the processor 46 operating as a control unit 46A according to the specific program 60 executed on the RAM 48. The robot 414 may also have similar data generation models and emotion identification models as the data generation model 58 and emotion identification model 59, and perform the same processing as the specific processing unit 290 using these models.

Other devices besides the data processing device 12 may have the data generation model 58. For example, a server device may have the data generation model 58. In this case, the data processing device 12 communicates with the server device having the data generation model 58 to obtain processing results (e.g., prediction results) using the data generation model 58. The data processing device 12 may be a server device or a terminal device owned by the user (e.g., a mobile phone, robot, home appliance, etc.).

The specific processing unit 290 sends the results of specific processing to the robot 414. In the robot 414, the control unit 46A causes the speaker 240 and the control target 443 to output the results of specific processing. The microphone 238 acquires voice indicating user input in response to the results of specific processing. The control unit 46A sends the voice data indicating user input acquired by the microphone 238 to the data processing device 12. In the data processing device 12, the specific processing unit 290 acquires the voice data.

The data generation model 58 is a so-called generative AI. An example of the data generation model 58 is a generative AI such as ChatGPT. The data generation model 58 is obtained by performing deep learning on a neural network. The data generation model 58 receives prompts containing instructions and inference data such as voice data indicating voice, text data indicating text, and image data indicating images (e.g., still image data or video data). The data generation model 58 performs inference according to the instructions indicated by the prompt on the input inference data and outputs the inference results in one or more data formats such as voice data, text data, or image data. The data generation model 58 includes, for example, text generation AI, image generation AI, and multimodal generation AI. Here, inference refers to, for example, analysis, classification, prediction, and/or summarization. The specific processing unit 290 performs the specific processing described above using the data generation model 58. The data generation model 58 may be a fine-tuned model that outputs inference results from prompts without instructions, and in this case, the data generation model 58 can output inference results from prompts without instructions. The data processing device 12 and the like may include multiple types of data generation models 58, and the data generation model 58 may include AI other than generative AI. AI other than generative AI may include, for example, linear regression, logistic regression, decision trees, random forests, support vector machines (SVM), k-means clustering, convolutional neural networks (CNN), recurrent neural networks (RNN), generative adversarial networks (GAN), or naive Bayes, among others, and can perform various processing but are not limited to such examples. Additionally, AI may be an AI agent. Furthermore, when processing is performed by AI in each part described above, the processing may be performed partially or entirely by AI but is not limited to such examples. Additionally, processing implemented by AI including generative AI may be replaced with rule-based processing, and rule-based processing may be replaced with processing implemented by AI including generative AI.

The data processing system 410 according to the fourth embodiment performs the same processing as the data processing system 10 according to the first embodiment. The processing by the data processing system 410 is executed by the specific processing unit 290 of the data processing device 12 or the control unit 46A of the robot 414, but it may be executed by both the specific processing unit 290 of the data processing device 12 and the control unit 46A of the robot 414. Additionally, the specific processing unit 290 of the data processing device 12 acquires or collects necessary information for processing from the robot 414 or external devices, and the robot 414 acquires or collects necessary information for processing from the data processing device 12 or external devices.

Each of the plurality of elements including the aforementioned receiving unit, analysis unit, generation unit, playback unit, and formatting unit is implemented, for example, by at least one of the robot 414 and the data processing device 12. For example, the receiving unit is implemented by a control unit 46A of the robot 414, allowing a user to load a video. The analysis unit is implemented, for example, by a specific processing unit 290 of the data processing device 12, and analyzes the content of the video to extract important parts. The generation unit is implemented, for example, by the control unit 46A of the robot 414, and generates highlight videos and text minutes. The playback unit is implemented, for example, by the specific processing unit 290 of the data processing device 12, and plays back the video based on a search word. The formatting unit is implemented, for example, by the control unit 46A of the robot 414, and generates minutes in a specified format. The correspondence between each unit and the device or control unit is not limited to the examples described above, and various modifications are possible.

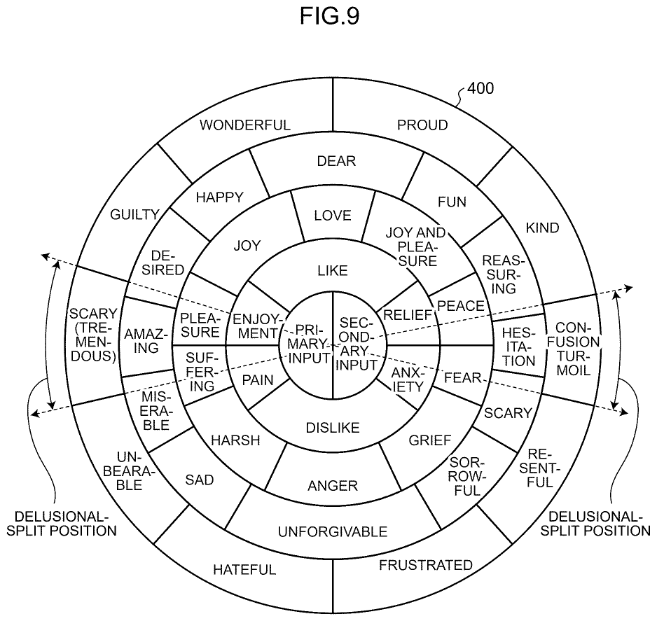

Note that the emotion identification model 59 as an emotion engine may determine the user's emotions according to a specific mapping. Specifically, the emotion identification model 59 may determine the user's emotions according to an emotion map, which is a specific mapping (see FIG. 9). Similarly, the emotion identification model 59 may determine the robot's emotions, and the specific processing unit 290 may perform specific processing using the robot's emotions.

FIG. 9 is a diagram showing an emotion map 400 where multiple emotions are mapped. In the emotion map 400, emotions are arranged concentrically radiating from the center. The closer to the center of the concentric circles, the more primitive the state of emotions is arranged. On the outer side of the concentric circles, emotions representing states and behaviors arising from mood are arranged. Emotions encompass concepts including emotional and mental states. On the left side of the concentric circles, emotions generally generated from reactions occurring in the brain are arranged. On the right side of the concentric circles, emotions generally induced by situational judgment are arranged. On the top and bottom of the concentric circles, emotions generated from reactions occurring in the brain and induced by situational judgment are arranged. Additionally, on the upper side of the concentric circles, “pleasant” emotions are arranged, and on the lower side, “unpleasant” emotions are arranged. In this way, in the emotion map 400, multiple emotions are mapped based on the structure from which emotions arise, and emotions that tend to occur simultaneously are mapped nearby.

These emotions are distributed in the 3 o'clock direction of the emotion map 400, and they usually move back and forth around reassurance and anxiety. In the right half of the emotion map 400, situational recognition takes precedence over internal sensations, giving a calm impression.

The inner side of the emotion map 400 represents the mind, and the outer side represents behavior, so the further out on the emotion map 400, the more visible (expressed in behavior) emotions become.

Here, human emotions are based on various balances like posture and blood sugar levels, and when these balances move away from the ideal, they indicate discomfort, and when they approach the ideal, they indicate comfort. In robots, cars, motorcycles, etc., emotions can be created based on various balances like posture and battery level, indicating discomfort when these balances move away from the ideal and comfort when they approach the ideal. The emotion map may be generated based on Dr. Mitsuyoshi's emotion map (Research on speech emotion recognition and brain physiological signal analysis systems related to emotions, Tokushima University, Doctoral dissertation: https://ci.nii.ac.jp/naid/500000375379). In the left half of the emotion map, emotions belonging to the domain called “reactions,” where sensations take precedence, are aligned. Additionally, in the right half of the emotion map, emotions belonging to the domain called “situations,” where situational recognition takes precedence, are aligned.

In the emotion map, two emotions that promote learning are defined. One is a negative emotion around “repentance” or “reflection” on the situation side. In other words, when a negative emotion arises in the robot, like “I never want to feel this way again” or “I don't want to be scolded again.” The other is an emotion around “desire” on the reaction side, which is positive. In other words, it is a positive feeling like “I want more” or “I want to know more.”

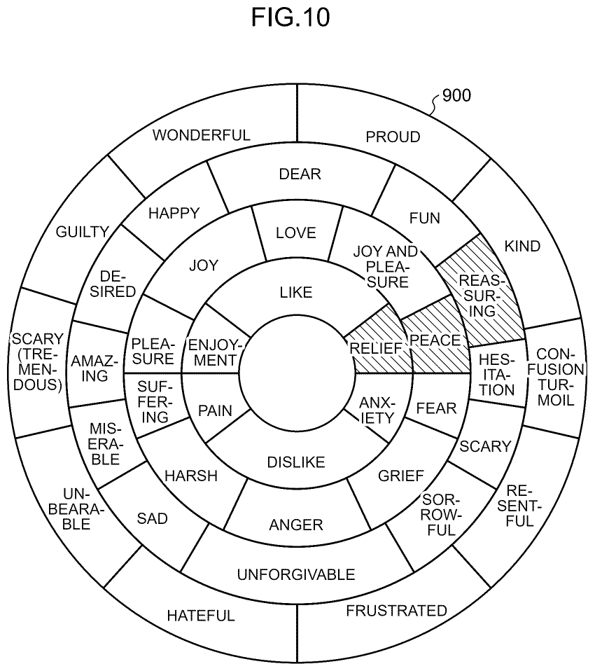

The emotion identification model 59 inputs user input into a pre-learned neural network, acquires emotion values indicating each emotion shown in the emotion map 400, and determines the user's emotions. This neural network is pre-learned based on multiple training data consisting of user input and combinations of emotion values indicating each emotion shown in the emotion map 400. Additionally, this neural network is learned so that emotions placed near each other in the emotion map 900 shown in FIG. 10 have similar values. FIG. 10 shows an example where multiple emotions like “reassured,” “calm,” and “confident” have similar emotion values.

In the above embodiments, an example form where specific processing is performed by a single computer 22 was described, but the technology disclosed herein is not limited to this, and distributed processing for specific processing by multiple computers including the computer 22 may be performed.

In the above embodiments, an example form where the specific processing program 56 is stored in the storage 32 was described, but the technology disclosed herein is not limited to this. For example, the specific processing program 56 may be stored in portable non-transitory storage media readable by a computer, such as a USB (Universal Serial Bus) memory. The specific processing program 56 stored in non-transitory storage media is installed in the computer 22 of the data processing device 12. The processor 28 executes specific processing according to the specific processing program 56.

Additionally, the specific processing program 56 may be stored in a storage device, such as a server connected to the data processing device 12 via the network 54, and downloaded and installed on the computer 22 in response to requests from the data processing device 12.

Furthermore, it is not necessary to store all of the specific processing program 56 in storage devices such as servers connected to the data processing device 12 via the network 54 or all in the storage 32, and a part of the specific processing program 56 may be stored.

Various processors, as shown next, can be used as hardware resources for executing specific processing. As processors, general-purpose processors that function as hardware resources for executing specific processing by executing software, i.e., programs, such as a CPU, can be mentioned. Additionally, as processors, dedicated electrical circuits with circuit configurations specially designed to execute specific processing, such as FPGA (Field-Programmable Gate Array), PLD (Programmable Logic Device), or ASIC (Application Specific Integrated Circuit), can be mentioned. Each processor has a built-in or connected memory, and each processor executes specific processing using the memory.

Hardware resources for executing specific processing may be composed of one of these various processors or a combination of two or more processors of the same or different types (e.g., a combination of multiple FPGAs or a combination of a CPU and FPGA). Additionally, hardware resources for executing specific processing may be a single processor.

As an example of composing with a single processor, firstly, there is a form where one or more CPUs and software are combined to constitute a single processor, which functions as hardware resources for executing specific processing. Secondly, there is a form using a processor, such as SoC (System-on-a-chip), that realizes the function of an entire system including multiple hardware resources for executing specific processing with a single IC chip. In this way, specific processing is realized using one or more of the various processors as hardware resources.

Furthermore, as a hardware structure of these various processors, more specifically, electrical circuits combined with circuit elements such as semiconductor elements can be used. Additionally, the specific processing described above is merely one example. Therefore, it goes without saying that unnecessary steps may be deleted, new steps may be added, or the order of processing may be changed within the scope not departing from the gist.

Additionally, in the examples described above, the explanation was divided into the first embodiment to the fourth embodiment, but parts or all of these embodiments may be combined. Additionally, the smart device 14, smart glasses 214, headset-type terminal 314, and robot 414 are examples, and each may be combined, or other devices may be used.

The descriptions and drawings shown above are detailed explanations of parts related to the technology disclosed herein and are merely examples of the technology disclosed herein. For example, the explanations regarding configurations, functions, actions, and effects above are explanations regarding examples of configurations, functions, actions, and effects of parts related to the technology disclosed herein. Therefore, it goes without saying that within the scope not departing from the gist of the technology disclosed herein, unnecessary parts may be deleted, new elements may be added, or replacements may be made to the descriptions and drawings shown above. Additionally, to avoid complexity and facilitate understanding of parts related to the technology disclosed herein, explanations concerning technical common knowledge and the like that do not require special explanation for enabling the implementation of the technology disclosed herein are omitted in the descriptions and drawings shown above.

All documents, patent applications, and technical standards described in this specification are incorporated by reference to the same extent as if each document, patent application, and technical standard were specifically and individually stated to be incorporated by reference in this specification.
(Supplementary Note 1) A system comprising: a receiving unit configured to load a video; an analysis unit configured to analyze the video loaded by the receiving unit; a generation unit configured to generate minutes based on the video analyzed by the analysis unit; a playback unit configured to play back the video based on a search word; and a formatting unit configured to generate minutes in a specified format.
(Supplementary Note 2) The system according to Supplementary Note 1, further comprising a highlight unit configured to generate a highlight video.
(Supplementary Note 3) The system according to Supplementary Note 1, further comprising a text unit configured to generate text.
(Supplementary Note 4) The system according to Supplementary Note 1, further comprising a search unit configured to input a search word.
(Supplementary Note 5) The system according to Supplementary Note 1, further comprising a control unit configured to control playback of the video.
(Supplementary Note 6) The system according to Supplementary Note 1, wherein the receiving unit is configured to estimate a user's emotion and adjust the timing of video reception based on the estimated emotion of the user.
(Supplementary Note 7) The system according to Supplementary Note 1, wherein the receiving unit is configured to analyze a user's past video reception history and select an appropriate reception method.
(Supplementary Note 8) The system according to Supplementary Note 1, wherein the receiving unit is configured to perform filtering at the time of video reception based on the user's current project or field of interest.
(Supplementary Note 9) The system according to Supplementary Note 1, wherein the receiving unit is configured to estimate a user's emotion and determine the priority of videos to be received based on the estimated emotion of the user.
(Supplementary Note 10) The system according to Supplementary Note 1, wherein the receiving unit is configured to consider the user's geographic location information at the time of video reception and preferentially receive highly relevant videos.
(Supplementary Note 11) The system according to Supplementary Note 1, wherein the receiving unit is configured to analyze the user's social media activity at the time of video reception and receive related videos.
(Supplementary Note 12) The system according to Supplementary Note 1, wherein the analysis unit is configured to estimate a user's emotion and adjust the method of expression in analysis based on the estimated emotion of the user.
(Supplementary Note 13) The system according to Supplementary Note 1, wherein the analysis unit is configured to adjust the level of detail in analysis based on the importance of the video during analysis.
(Supplementary Note 14) The system according to Supplementary Note 1, wherein the analysis unit is configured to apply different analysis algorithms according to the category of the video during analysis.
(Supplementary Note 15) The system according to Supplementary Note 1, wherein the analysis unit is configured to estimate a user's emotion and adjust the length of analysis based on the estimated emotion of the user.
(Supplementary Note 16) The system according to Supplementary Note 1, wherein the analysis unit is configured to determine the priority of analysis based on the shooting time of the video during analysis.
(Supplementary Note 17) The system according to Supplementary Note 1, wherein the analysis unit is configured to adjust the order of analysis based on the relevance of the video during analysis.
(Supplementary Note 18) The system according to Supplementary Note 1, wherein the generation unit is configured to estimate a user's emotion and adjust the method of expression in the minutes to be generated based on the estimated emotion of the user.
(Supplementary Note 19) The system according to Supplementary Note 1, wherein the generation unit is configured to adjust the level of detail in the minutes to be generated based on the importance of the video during generation.
(Supplementary Note 20) The system according to Supplementary Note 1, wherein the generation unit is configured to apply different generation algorithms according to the category of the video during generation.
(Supplementary Note 21) The system according to Supplementary Note 1, wherein the generation unit is configured to estimate a user's emotion and adjust the length of the minutes to be generated based on the estimated emotion of the user.
(Supplementary Note 22) The system according to Supplementary Note 1, wherein the generation unit is configured to determine the priority of the minutes to be generated based on the shooting time of the video during generation.
(Supplementary Note 23) The system according to Supplementary Note 1, wherein the generation unit is configured to adjust the order of the minutes to be generated based on the relevance of the video during generation.
(Supplementary Note 24) The system according to Supplementary Note 1, wherein the playback unit is configured to estimate a user's emotion and adjust the timing of playback based on the estimated emotion of the user.
(Supplementary Note 25) The system according to Supplementary Note 1, wherein the playback unit is configured to adjust the level of detail in playback based on the importance of the video during playback.
(Supplementary Note 26) The system according to Supplementary Note 1, wherein the playback unit is configured to apply different playback algorithms according to the category of the video during playback.
(Supplementary Note 27) The system according to Supplementary Note 1, wherein the playback unit is configured to estimate a user's emotion and adjust the length of playback based on the estimated emotion of the user.
(Supplementary Note 28) The system according to Supplementary Note 1, wherein the playback unit is configured to determine the priority of playback based on the shooting time of the video during playback.
(Supplementary Note 29) The system according to Supplementary Note 1, wherein the playback unit is configured to adjust the order of playback based on the relevance of the video during playback.
(Supplementary Note 30) The system according to Supplementary Note 1, wherein the formatting unit is configured to estimate a user's emotion and select a format based on the estimated emotion of the user.
(Supplementary Note 31) The system according to Supplementary Note 1, wherein the formatting unit is configured to refer to past format usage history and select an appropriate format at the time of format selection.
(Supplementary Note 32) The system according to Supplementary Note 1, wherein the formatting unit is configured to apply different formats according to the category of the video at the time of format selection.
(Supplementary Note 33) The system according to Supplementary Note 1, wherein the formatting unit is configured to estimate a user's emotion and determine the priority of formats based on the estimated emotion of the user.
(Supplementary Note 34) The system according to Supplementary Note 1, wherein the formatting unit is configured to determine the priority of formats based on the shooting time of the video at the time of format selection.
(Supplementary Note 35) The system according to Supplementary Note 1, wherein the formatting unit is configured to adjust the order of formats based on the relevance of the video at the time of format selection.
(Supplementary Note 36) The system according to Supplementary Note 2, wherein the highlight unit is configured to estimate a user's emotion and adjust the method of highlight generation based on the estimated emotion of the user.
(Supplementary Note 37) The system according to Supplementary Note 2, wherein the highlight unit is configured to adjust the level of detail in highlight generation based on the importance of the video during highlight generation.
(Supplementary Note 38) The system according to Supplementary Note 2, wherein the highlight unit is configured to apply different highlight generation algorithms according to the category of the video during highlight generation.
(Supplementary Note 39) The system according to Supplementary Note 2, wherein the highlight unit is configured to estimate a user's emotion and adjust the length of the highlight based on the estimated emotion of the user.
(Supplementary Note 40) The system according to Supplementary Note 2, wherein the highlight unit is configured to determine the priority of highlights based on the shooting time of the video during highlight generation.
(Supplementary Note 41) The system according to Supplementary Note 2, wherein the highlight unit is configured to adjust the order of highlights based on the relevance of the video during highlight generation.
(Supplementary Note 42) The system according to Supplementary Note 3, wherein the text unit is configured to estimate a user's emotion and adjust the method of text generation based on the estimated emotion of the user.
(Supplementary Note 43) The system according to Supplementary Note 3, wherein the text unit is configured to adjust the level of detail in text generation based on the importance of the video during text generation.
(Supplementary Note 44) The system according to Supplementary Note 3, wherein the text unit is configured to apply different text generation algorithms according to the category of the video during text generation.
(Supplementary Note 45) The system according to Supplementary Note 3, wherein the text unit is configured to estimate a user's emotion and adjust the length of the text based on the estimated emotion of the user.
(Supplementary Note 46) The system according to Supplementary Note 3, wherein the text unit is configured to determine the priority of text based on the shooting time of the video during text generation.
(Supplementary Note 47) The system according to Supplementary Note 3, wherein the text unit is configured to adjust the order of text based on the relevance of the video during text generation.
(Supplementary Note 48) The system according to Supplementary Note 4, wherein the search unit is configured to estimate a user's emotion and select a search word based on the estimated emotion of the user.
(Supplementary Note 49) The system according to Supplementary Note 4, wherein the search unit is configured to refer to past search history and propose an optimal search word at the time of searching.
(Supplementary Note 50) The system according to Supplementary Note 4, wherein the search unit is configured to apply different search algorithms according to the category of the video at the time of searching.
(Supplementary Note 51) The system according to Supplementary Note 4, wherein the search unit is configured to estimate a user's emotion and adjust the method of displaying search results based on the estimated emotion of the user.
(Supplementary Note 52) The system according to Supplementary Note 4, wherein the search unit is configured to determine the priority of search results based on the shooting time of the video at the time of searching.
(Supplementary Note 53) The system according to Supplementary Note 4, wherein the search unit is configured to adjust the order of search results based on the relevance of the video at the time of searching.
(Supplementary Note 54) The system according to Supplementary Note 5, wherein the control unit is configured to estimate a user's emotion and adjust the method of playback control based on the estimated emotion of the user.
(Supplementary Note 55) The system according to Supplementary Note 5, wherein the control unit is configured to adjust the level of detail in playback based on the importance of the video during playback control.
(Supplementary Note 56) The system according to Supplementary Note 5, wherein the control unit is configured to apply different playback control algorithms according to the category of the video during playback control.
(Supplementary Note 57) The system according to Supplementary Note 5, wherein the control unit is configured to estimate a user's emotion and adjust the timing of playback control based on the estimated emotion of the user.
(Supplementary Note 58) The system according to Supplementary Note 5, wherein the control unit is configured to determine the priority of playback based on the shooting time of the video during playback control.
(Supplementary Note 59) The system according to Supplementary Note 5, wherein the control unit is configured to adjust the order of playback based on the relevance of the video during playback control.

What is claimed is:

1. A system comprising:
a communication interface configured to communicate with a client terminal via a packet-switched network;
a memory storing a video analysis model and a text generation model, each obtained by machine learning; and
circuitry configured to:
receive, from the client terminal via the communication interface, video data representing a video captured by a camera of the client terminal;
analyze the video data by inputting the video data into the video analysis model to extract, for each segment of the video data, a feature vector and an importance score;
generate minutes data by inputting the feature vector and the importance score into the text generation model to produce at least one of a highlight timestamp sequence or a summary text;
receive, from the client terminal via the communication interface, query data representing a search word;
identify a playback position in the video data by comparing the query data with the feature vector; and
transmit the minutes data and the playback position to the client terminal via the communication interface and the packet-switched network.

2. The system according to claim 1, wherein the video analysis model comprises at least one of a convolutional neural network configured to detect faces and scene transitions in the video data, a recurrent neural network configured to perform speech recognition on audio data extracted from the video data, or a Transformer-based model configured to extract keywords from speech text.

3. The system according to claim 1, wherein the text generation model comprises a Transformer-based summarization model configured to receive speech text and output at least one of a summary sentence or a full transcript with timestamps.

4. The system according to claim 1, wherein the circuitry is further configured to generate the highlight timestamp sequence by sorting segments by the importance score and selecting segments having an importance score exceeding a threshold.

5. The system according to claim 1, wherein the circuitry is further configured to generate a highlight video by concatenating video segments corresponding to the highlight timestamp sequence using a video editing algorithm.

6. The system according to claim 1, wherein the circuitry is further configured to estimate an emotion of a user by applying an emotion identification model to sensor data received from the client terminal, and adjust a timing of receiving the video data based on the estimated emotion.

7. The system according to claim 6, wherein the sensor data comprises at least one of facial image data captured by the camera, audio waveform data captured by a microphone, or text data input by the user.

8. The system according to claim 1, wherein the circuitry is further configured to estimate an emotion of a user and adjust a format of the minutes data based on the estimated emotion, such that when the estimated emotion indicates relaxation, the circuitry generates detailed minutes data, and when the estimated emotion indicates urgency, the circuitry generates concise minutes data.

9. The system according to claim 1, wherein the circuitry is further configured to identify the playback position by generating a semantic vector from the query data using a semantic search model and calculating a cosine similarity between the semantic vector and the feature vector.

10. The system according to claim 1, wherein the circuitry is further configured to generate the minutes data in a specified output format comprising at least one of a PDF format, a Word format, or an HTML format.

11. The system according to claim 1, wherein the circuitry is further configured to extract, from the video data, audio data and convert the audio data into speech text using an automatic speech recognition model before inputting the speech text into the text generation model.

12. The system according to claim 1, wherein the circuitry is further configured to detect, for each segment of the video data, a speaker identity by extracting a voiceprint feature from audio data of the segment.

13. The system according to claim 1, wherein the circuitry is further configured to identify the playback position at a timestamp preceding an appearance of the search word in the video data by a predetermined offset.

14. The system according to claim 1, wherein the circuitry is further configured to analyze a past video reception history associated with a user and select a reception method for the video data based on the past video reception history.

15. The system according to claim 1, wherein the circuitry is further configured to adjust a playback speed of the video data based on an instruction received from the client terminal and perform pitch correction on audio data of the video data.

16. The system according to claim 1, wherein the circuitry is further configured to determine a priority of the minutes data based on a shooting time of the video data, such that minutes data for more recent video data is generated with higher priority.

17. The system according to claim 1, wherein the circuitry is further configured to filter the video data based on a current project or field of interest of a user before analyzing the video data.

18. A system comprising:
a communication interface configured to communicate with a client terminal via a packet-switched network;
a processor;
a random-access memory;
a memory storing a video analysis model comprising a convolutional neural network and a recurrent neural network, a text generation model comprising a Transformer-based summarization model, and an emotion identification model; and
circuitry configured to:
receive, from the client terminal via the communication interface, video data representing a video;
extract audio data from the video data and convert the audio data into speech text by inputting the audio data into the recurrent neural network;
analyze the video data by inputting frame data into the convolutional neural network to detect faces and scene transitions, and inputting the speech text into the text generation model to extract, for each segment, a feature vector and an importance score;
estimate an emotion of a user by applying the emotion identification model to sensor data received from the client terminal;
generate minutes data comprising at least one of a highlight timestamp sequence or a summary text based on the importance score and the estimated emotion; and
transmit the minutes data to the client terminal via the communication interface.

19. The system according to claim 18, wherein the circuitry is further configured to receive query data representing a search word from the client terminal, identify a playback position in the video data by comparing a semantic vector of the query data with the feature vector, and transmit the playback position to the client terminal.

20. A method comprising:
receiving, from a client terminal via a communication interface, video data representing a video captured by a camera of the client terminal;
analyzing the video data by inputting the video data into a video analysis model obtained by machine learning to extract, for each segment of the video data, a feature vector and an importance score;
generating minutes data by inputting the feature vector and the importance score into a text generation model obtained by machine learning to produce at least one of a highlight timestamp sequence or a summary text;
receiving, from the client terminal via the communication interface, query data representing a search word;
identifying a playback position in the video data by comparing the query data with the feature vector; and
transmitting the minutes data and the playback position to the client terminal via the communication interface and a packet-switched network.
